(19) United States
(12) Patent Application Publication
(10) Pub. No.: US 2026/0299119 A1
(43) Pub. Date: Oct. 1, 2026

(54) PRIORITIZED TWO STAGE MONOSTATIC SENSING

(71) Applicant: InterDigital Patent Holdings, Inc., Wilmington, DE (US)

(72) Inventors: Remun Koirala, London (GB); Fumihiro Hasegawa, Westmount (CA); Jonghyun Park, Syosset, NY (US); Paul Marinier, Brossard (CA); Moon IL Lee, Melville, NY (US); Ognen Ognenoski, London (GB); Ghyslain Pelletier, Montreal (CA)

(73) Assignee: InterDigital Patent Holdings, Inc., Wilmington, DE (US)

(21) Appl. No.: 19/480,462

(22) PCT Filed: May 3, 2024
(86) PCT No.: PCT/US2024/027611

§ 371 Date: Oct. 31, 2025

Related U.S. Application Data
(60) Provisional application No. 63/465,054, filed on May 9, 2023.

(51) Int. Cl. G01S 13/93; G01S 7/292; G01S 7/41; G01S 13/42; H04B 17/318

(52) U.S. Cl. CPC G01S 13/93; G01S 7/2925; G01S 7/415; G01S 13/422; H04B 17/328

(57) ABSTRACT

Systems, methods, devices, and instrumentalities are described herein related to prioritized two stage monostatic sensing. A device, such as a WTRU, may perform one or more of the following. The device may detect an obstacle based on a positioning transmission associated with obstacle sensing. The device may send an indication of measurement information associated with the obstacle and the temporary obstacle ID to a network device. The device may receive an indication of a definite obstacle ID associated with the temporary obstacle ID from the network device. The device may determine a set of resources associated with the obstacle based on a priority associated with the definite obstacle ID. The device may perform a measurement associated with a transmission of a SRSp in the set of resources to determine an estimated location of the obstacle.

### CROSS REFERENCE TO RELATED APPLICATIONS

This application claims the benefit of Provisional Patent Application No. 63/465,054, filed May 9, 2023, the contents of which are hereby incorporated by reference herein.

### BACKGROUND

Mobile communications using wireless communication continue to evolve. A fifth generation may be referred to as 5G. A previous (legacy) generation of mobile communication may be, for example, fourth generation (4G) long term evolution (LTE).

### SUMMARY

Systems, methods, devices, and instrumentalities are described herein related to prioritized two stage monostatic sensing. For example, a device, such as a wireless transmit/receive unit (WTRU), may incorporate a detection stage associated with the detection of obstacles and an estimation stage associated with estimation of the location of detected obstacles. Resource allocation between these stages and prioritization conditions may be specified, for example in cases involving detection of multiple obstacles. Obstacle and/or blockage aware operation (e.g., beamforming, handover) may improve communication performance and positioning accuracy.

A device, such as a WTRU, may (e.g., be configured to) perform one or more of the following. The device may detect an obstacle based on a positioning transmission associated with obstacle sensing. For example, the device may detect the obstacle by determining a difference between a measured reference signal received power (RSRP) between measurement occasions exceeds a threshold. The device may associate a temporary obstacle ID with the detected obstacle. The device may send, e.g., to a network device, an indication of measurement information associated with the obstacle and the temporary obstacle ID.

The device may receive, e.g., from the network device, an indication of a definite obstacle ID associated with the temporary obstacle ID. The device may determine a set of resources associated with the obstacle based on a priority associated with the definite obstacle ID. In examples, the priority associated with the definite obstacle ID may be provided by the network (e.g., via the indication including the definite obstacle ID) or may be determined by the device. For example, the device may determine a priority associated with the definite obstacle ID based on a distance between the WTRU and the obstacle, an estimated velocity of the obstacle, a direction of movement of the obstacle, and/or a measured reference signal received power (RSRP) associated with the obstacle.

A priority may be associated with a set of resources (e.g., each respective priority may be associated with a respective set of resources). The set of resources may be allocated proportionally, based on priority, or equally. In examples, a higher priority obstacle may be allocated a higher amount of resources. Similar resources may be allocated for obstacles with a priority above a threshold. The set of resources may be based on a number of obstacles to be located or a number of obstacles with a respective priority above a priority threshold.

The device may perform a measurement associated with a transmission of a SRSp in the set of resources to determine an estimated location of the obstacle. The device may send estimated location information associated with the obstacle to the network. The estimated location information associated with the obstacle may indicate the definite obstacle ID, the estimated location associated with the obstacle, and/or the priority associated with the obstacle.

A device (e.g. a wireless transmit/receive unit (WTRU)) may include a processor configured to perform one or more actions. The device may receive an indication to initiate obstacle sensing, perform a positioning transmission associated with the obstacle sensing, and detect a first obstacle and a second obstacle. The device may send an indication of the detected obstacles to a network device (e.g., a base station), wherein the indication may include a first temporary obstacle ID associated with the first obstacle, first measurement information associated with the first temporary obstacle ID or the first obstacle, a second temporary obstacle IDs associated with the second obstacle, and/or second measurement information associated with the second temporary obstacle ID or the second obstacle. The device may receive an indication from the network device indicating a first definite obstacle ID associated with the first temporary obstacle ID, a first priority associated with the first definite obstacle ID, a second definite obstacle ID associated with the second temporary obstacle ID, and/or a second priority associated with the second definite obstacle ID. The device may determine a first estimated location for the first obstacle based on the first priority and a second estimated location for the second obstacle based on the second priority.

The determination of the first estimated location for the first obstacle based on the first priority by the device may include use of a first resource(s) or a first resource set(s) associated with the first priority. The determination of the second estimated location for the second obstacle based on the second priority by the device may include use of a second resource(s) or a second resource set(s) associated with the second priority. Resource(s) may comprise to one or more SRSp resources different in time and/or frequency. A resource set may comprise of a group of resources.

The processor of the device may be further configured to receive configuration information that may associate the first resource(s) or the first resource set(s) with the first priority, and/or associate the second resource(s) or the second resource set(s) with the second priority. The processor of the device may be further configured to use the first resource(s) or the first resource set(s) based on the received configuration information and the indicated first priority and/or to use the second resource(s) or the second resource set(s) based on the received configuration information and the indicated second priority.

The processor of the device may be further configured to send, to the network device, information that indicates the first estimated location for the first obstacle and/or the second estimated location for the second obstacle. The information that indicates the first estimated location for the first obstacle may include an indication of the first definite obstacle ID or the first priority, and/or the information that indicates the second estimated location for the second obstacle may include an indication of the second definite obstacle ID or the second priority.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 illustrates an example sensing process.

FIG. 3 illustrates an example sounding reference signal for positioning (SRSp) configuration.

FIG. 4 illustrates an example of beam sweeping, obstacle detection, temporary obstacle ID allocation, and obstacle prioritization.

FIG. 5 illustrates an example of SRSp resources and a coverage angle.

FIG. 6 illustrates an example of line of sight (LoS) and non-line of sight (NLoS) measurement paths.

FIG. 7 illustrates an example resource allocation.

FIG. 8 is an example priority dependent resource allocation.

FIG. 9 illustrates an example resource allocation.

FIG. 10 illustrates an example estimation phase.

FIG. 11 illustrates example resource allocations.

FIG. 12 illustrates example SRSp resource alignments.

### DETAILED DESCRIPTION

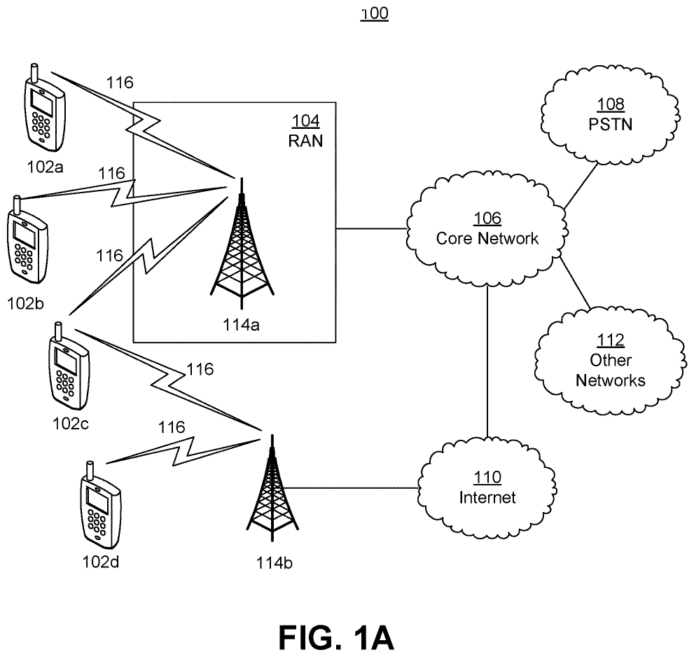

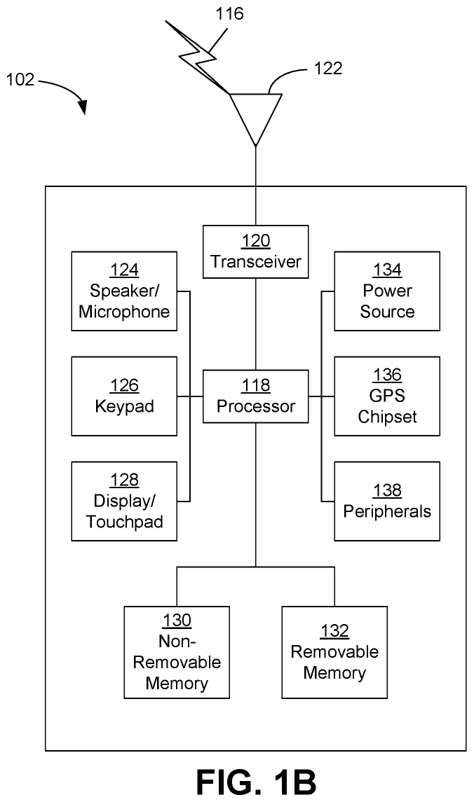

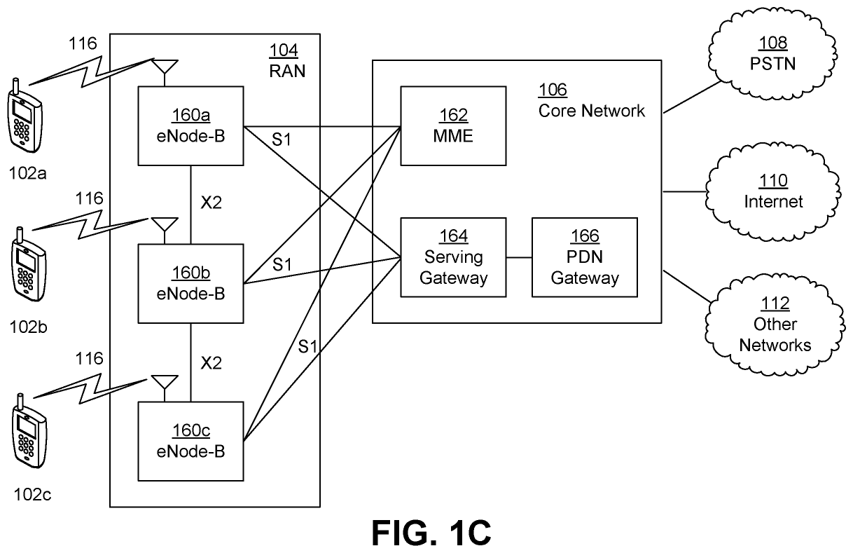

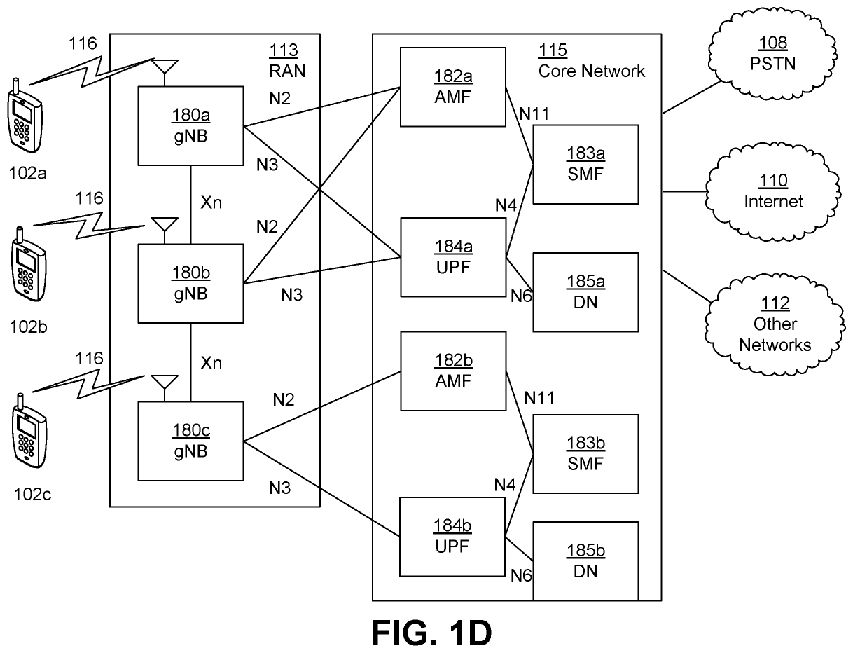

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHZ, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHZ, 4 MHz, 8 MHZ, 16 MHZ, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Sensing (e.g., NR Sensing) may involve detecting, estimating, and/or monitoring conditions of the environment and/or objects within the environment (e.g., shape, size, orientation, speed, location, distances or relative motion between objects, etc.) using RF signals (e.g., NR RF signals).

Different modes of sensing may be used. For example, sensing may be categorized into monostatic sensing and bistatic sensing depending on the transmitter and receiver location. Monostatic sensing may refer to a sensing mode with a co-located transmitter and receiver. Bistatic sensing may refer to a sensing mode with a non-co-located transmitter and receiver.

The term monostatic in radar may be used where a transmitter transmits reference pulses which bounce back from a target/obstacle as a backscattered signal. The backscattered signal may be received by the receiver to perform various tasks (e.g., target detection, estimation, tracking and classification).

In NR, monostatic sensing may utilize a co-located transmitter and receiver and may be employed at the WTRU side or at the network (e.g., gNB) side. This mode of sensing may advantageously use one terminal is required for sensing (e.g., rather than two) and the clock may be synchronized. This mode may require full duplex (FD) capabilities (e.g., as the terminal may transmit and receive transmitted signals simultaneously).

FD capable terminals may be WTRUs capable of simultaneous transmission and reception of wireless signals improving communication capacity, reducing latency, etc. An FD capable terminal may be a non-limiting example of a type of WTRU that supports the simultaneous transmission and reception of wireless signals in a same frequency band. Other types of WTRU capabilities may be substituted for the FD capability. The transmission and reception functionality in the WTRU may be allocated to different sub-bands (e.g., non-overlapping sub-band FD) or may be split by separate physical transmit and receive antennas (e.g., antenna group, group of antenna port(s), antenna panel) while being transmitted and received in the same frequency band.

Each of the position reference signal (PRS) and/or sounding reference signal for positioning (SRSp) resources may be allocated in the time and frequency orthogonal frequency-division multiplexing (OFDM) grid of the transmitter. These resources may also be transmitted as directional beams. The full set of directional beams transmitted by a transmission reception point (TRP) or a WTRU in the same frequency may be referred to as a PRS resource set.

At positioning occasions, the PRS and/or SRSp configuration may account for the time, frequency, and/or spatial domain arrangement of the reference signals. In the time domain, the configuration may include a starting symbol and a total number of symbols where PRS and/or SRS is allocated. Similarly, in the frequency domain, the configuration may include a starting resource element and/or a total bandwidth allocated for positioning. In the spatial domain, the PRS and/or SRSp resource configuration may be characterized by multiple resource sets. A (e.g., each) resource set may comprise a set of PRS and/or SRS beams with associated resource ID, beam direction in zenith and azimuth, and/or beamwidth.

In positioning occasions, multiple measurements from different TRP or WTRU may be required (e.g., for accurate positioning). Positioning occasions may comprise PRS or SRS resource multiplexing from different TRPs or WTRUs in time, frequency, and/or space. To allow for multiplexing, the PRS or SRS resources may be allocated in a staggered comb arrangement for each TRP or WTRU.

The PRS and/or SRSp transmission may occur in multiple positioning occasions. Between different positioning occasions, the PRS resources may be transmitted in a periodic, semi-periodic, or aperiodic fashion, for example, depending upon to the positioning requirements and ability of the target WTRU. The additional PRS or SRSp configuration may include the periodicity to indicate these transmissions for multiple PRS or SRSp occasions.

Positioning methods may be defined in downlink (DL) and uplink (UL).

In downlink positioning methods, the PRS resources from multiple TRPs may be transmitted to the target WTRU. The signal propagation environment may change some of the properties of the transmitted signal such as the signal amplitude, frequency, and/or phase (e.g., which may be measured by the WTRU as RSRP, RSTD, doppler shifts, etc.) The WTRU may infer intermediate positioning metrics, such as delay between the TRP and the WTRU, with downlink time difference of arrival (DL-TDoA) or the angle with downlink angle of departure (DL-AoD) using these measurements.

In uplink positioning methods, the SRSp resources may be transmitted by the WTRU to multiple TRPs. Upon reception, the TRPs may measure the RSRP, RSTD, doppler shift, etc. from each of the resources. The TRP may infer the positioning metrics, such as delay, with uplink time difference of arrival (UL-TDoA) or the angle with uplink angle of arrival (UL-AoA).

A combination of downlink and uplink methods may include the TRP transmitting the PRS and the WTRU transmitting SRSp (e.g., upon DL-PRS reception). This method may generate a two-way range between the TRP and the target WTRU and may eliminate TRP-WTRU clock synchronization errors.

The measurements and metrics at the WTRU and/or TRP(s) may be fused together at the WTRU, TRP, or the network to estimate the location of the target WTRU (e.g., in terms of either 2D or 3D coordinates).

Positioning architecture may comprise three main entities, the target WTRU, NG-RAN (e.g., comprising a NR gNB or LTE ng-eNB TRPs), and the core network (e.g., 5G core network (5GC)) comprising an access and mobility management function (AMF) and a location management function (LMF).

Depending on whether the positioning is WTRU-based or WTRU-assisted, the role of one or more of these entities may include one or more of: requesting/transmitting positioning assistance information, requesting/transmitting DL-PRS/UL-SRS resources, measuring and/or transmitting the positioning metrics, or measuring and transmitting the final position estimate.

Various interfaces over which messages may be transmitted to different entities may also be defined. These include, for example, the NG-C interface (e.g., which may connect the NG-RAN and the 5G core network) and the NR/LTE Uu interface (e.g., which may connect the WTRU and the NG-RAN).

There may be different signaling protocols for exchanging positioning information and measurements between the entities. These include, for example, new radio primary/primary access (NRPPa) (e.g., between the NG-RAN Node and the LMF over NG-C interface), radio resource control (RRC) (e.g., between the gNB/ng-eNB and the WTRU over the NR/LTE-Uu interface), and LTE positioning protocol (LPP) (e.g., between the WTRU and the LMF over the NG-C and NR/LTE-Uu interface).

A device (e.g. a wireless transmit/receive unit (WTRU) may include a processor configured to perform one or more actions. The device may receive an indication to initiate obstacle sensing, perform a positioning transmission associated with the obstacle sensing, and detect a first obstacle and a second obstacle. The device may send an indication of the detected obstacles to a network device (e.g., a base station), wherein the indication may include a first temporary obstacle ID associated with the first obstacle, first measurement information associated with the first temporary obstacle ID or the first obstacle, a second temporary obstacle IDs associated with the second obstacle, and/or second measurement information associated with the second temporary obstacle ID or the second obstacle. The device may receive an indication from the network device indicating a first definite obstacle ID associated with the first temporary obstacle ID, a first priority associated with the first definite obstacle ID, a second definite obstacle ID associated with the second temporary obstacle ID, and/or a second priority associated with the second definite obstacle ID. The device may determine a first estimated location for the first obstacle based on the first priority and a second estimated location for the second obstacle based on the second priority.

The determination of the first estimated location for the first obstacle based on the first priority by the device may include use of a first resource(s) or a first resource set(s) associated with the first priority. The determination of the second estimated location for the second obstacle based on the second priority by the device may include use of a second resource(s) or a second resource set(s) associated with the second priority. Resource(s) may comprise to one or more SRSp resources different in time and/or frequency. A resource set may comprise a group of resources.

The processor of the device may be further configured to receive configuration information that may associate the first resource(s) or the first resource set(s) with the first priority, and/or associate the second resource(s) or the second resource set(s) with the second priority. The processor of the device may be further configured to use the first resource(s) or the first resource set(s) based on the received configuration information and the indicated first priority and/or to use the second resource(s) or the second resource set(s) based on the received configuration information and the indicated second priority.

The processor of the device may be further configured to send, to the network device, information that indicates the first estimated location for the first obstacle and/or the second estimated location for the second obstacle. The information that indicates the first estimated location for the first obstacle may include an indication of the first definite obstacle ID or the first priority, and/or the information that indicates the second estimated location for the second obstacle may include an indication of the second definite obstacle ID or the second priority.

In examples, one or more of the following may apply herein. “TRP” may be used interchangeably with “gNB” (e.g., base station) or “PRU.” A “Network” may refer to an AMF, LMF or gNB. A “location” may be used interchangeably with “position.” “ID” may be used interchangeably with “index”. A “measurement occasion” may be an instance where the WTRU measures the different positioning metric(s) (e.g., RSRP, ToF, etc.). A LOS path between the WTRU and the obstacle may refer to a direct path between the WTRU and the obstacle. A NLoS path between the WTRU and the obstacle may refer to a multi bounce path via other obstacles/ground reflections, etc. A radial velocity may refer to a velocity in the LoS direction from the transmitting entity. “RS” may refer to a positioning and reference signal, e.g., PRS, SRSp, CSI-RS, DM-RS, SSB etc. An absolute position may refer to the 2D or 3D position coordinate, e.g., with a global reference point. The global reference point may be common for the coordinates of the TRPs, WTRUs, and the obstacles. A relative position may refers to the 2D or 3D position coordinate with a local reference point (e.g., the WTRU). A coverage angle may refer to an angle covering a sector. SRS and SRSp may be used interchangeably. SRSp and RS may be used interchangeably. The WTRU may receive (pre) configured threshold(s) from the network (e.g., LMF, gNB). An LMF may be a non-limiting example of a node or entity (e.g., network node or entity) that may be used for or to support positioning. A node or entity, such as a gNB, may be substituted for LMF.

A PRS configuration may comprise (e.g., indicate) one or more of the following parameters: a number of symbols; a transmission power; a number of PRS resources included in PRS resource set; a muting pattern for PRS (e.g., the muting pattern may be expressed via a bitmap); a periodicity; a type of PRS (e.g., periodic, semi-persistent, or aperiodic); a slot offset (e.g., for periodic transmission for PRS); a vertical shift of PRS pattern in the frequency domain; a time gap during repetition; a repetition factor; a resource element (RE) offset; a comb pattern; a comb size; a spatial relation; QCL information (e.g., QCL target, QCL source) for PRS; a number of PRUs; a number of TRPs; an absolute radio-frequency channel number (ARFCN); a subcarrier spacing; an expected reference signal time difference (RSTD); an uncertainty in expected RSTD; a start physical resource block (PRB); a bandwidth; a bandwidth part (BWP) ID; a number of frequency layers; a start/end time for PRS transmission; an on/off indicator for PRS; a TRP ID; a PRS ID; a cell ID; a global cell ID; a PRU ID; or an applicable time window. The WTRU may apply a PRS configuration under a condition that the current time is within the applicable time window.

SRS for positioning (SRSp) or SRS configuration information may include (e.g., indicate) one or more of: a resource ID; comb offset values, cyclic shift values; a start position in the frequency domain; a number of SRSp symbols; a shift in the frequency domain for SRSp; a frequency hopping pattern; a type of SRSp (e.g., aperiodic, semi-persistent or periodic); a sequence ID used to generate SRSp, or other IDs used to generate SRSp sequence; spatial relation information, indicating which reference signal (e.g., DL RS, UL RS, CSI-RS, SRS, DM-RS) or SSB (e.g., SSB ID, cell ID of the SSB) the SRSp is related to spatially (e.g., where the SRSp and DL RS may be aligned spatially); QCL information (e.g., a QCL relationship between SRSp and other reference signals or SSB); QCL type (e.g., QCL type A, QCL type B, QCL type D); resource set ID; a list of SRSp resources in the resource set; transmission power related information; pathloss reference information which may contain index for SSB, CSI-RS or PRS; a periodicity of SRSp transmission; and/or spatial information, such as spatial direction information of SRSp transmission (e.g., beam information, angles of transmission) and/or spatial direction information of DL RS reception (e.g., beam ID used to receive DL RS, angle of arrival).

Feature(s) associated with accurate detection and estimation of the location of the obstacles are provided herein. One or more features may provide prioritization conditions in case of detection of multiple obstacles. One or more features may include improved communication performance (e.g., with obstacle and blockage aware beamforming, handover, etc.), improved positioning accuracy (e.g., due to obstacle and blockage aware beamforming and LoS path identification), and/or enabling use cases (e.g., autonomous vehicles due to better collision avoidance and trajectory management).

Features associated with prioritized two stage sensing are provided herein. One or more features may be used to estimate the location of obstacles that may degrade the positioning accuracy of a wireless transmit/receive unit (WTRU). Knowing and/or estimating the location of obstacles may improve the ability of a network and/or a WTRU to determine optimal configurations for positioning. One or more features may enable a WTRU to detect and locate obstacles quickly, and to decide prioritization of locating obstacles.

A device (e.g., a WTRU) may (e.g., be configured to) perform one or more of the following. The device may detect an obstacle based on a positioning transmission associated with obstacle sensing. For example, the device may transmit SRSp resources and may determine an obstacle is present based on a reflection of the transmitted SRSp resources. For example, the device may detect an obstacle by determining a difference in measured reference signal received power (RSRP) is above a threshold.

The device may send an indication of measurement information and a temporary obstacle ID associated with the obstacle to a network device (e.g., a gNB). The temporary obstacle ID may be associated with (e.g., unique to) the device. For example, the temporary obstacle ID may incorporate a device ID (e.g., WTRU ID) associated with the device. In examples, the temporary obstacle ID associated with the detected obstacle may be determined (e.g., generated) by the device. In examples, the temporary obstacle ID associated with the detected obstacle may be selected from a set of temporary obstacle IDs provided by the network device.

The device may receive an indication of at least one definite obstacle ID associated with the temporary obstacle ID from the network device. For example, the device may receive multiple definite obstacle IDs associated with the reported temporary obstacle ID.

In examples, the device may be configured (e.g., by the network) to allocate a definite obstacle ID to the detected obstacle. For example, the device may receive a database of network tracked obstacles and definite obstacle IDs for obstacle tracking and ID allocation. The data based of network tracked obstacles may be based on obstacles with locations tracked by the device and/or be provided by the network to the device. If the detected obstacle is determined to not be in the database, the device may associate (e.g., allocate) a definite obstacle ID (e.g., an unused definite obstacle ID) with the detected object. If the detected obstacle is determined to be in the database, the device may associate the definite obstacle ID with the detected obstacle and update the location of the detected obstacle in the database.

The device may determine a priority (e.g., a categorically represented priority or a numerically represented priority) associated with the definite obstacle ID. For example, the priority associated with the obstacle ID may be provided by the network (e.g., when provisioning the definite obstacle ID). For example, the priority associated with the definite obstacle ID may be determined by the device. The device may determine priority for a (e.g., each) detected obstacle based on characteristics of the obstacle. This prioritization may be based on one or more of: an estimated ToF (e.g., the distance between the device and the detected obstacle); a measured RSRP; an estimated velocity of the obstacle; a direction (e.g., a relative or absolute direction) of the movement of the obstacle; or a communication or localization performance loss. If uncertainty associated with the location and/or movement of the detected obstacle is above a configured threshold, the device may determine to associate the obstacle with a high priority.

The device may determine a set of resources (e.g., SRSp resources) associated with the obstacle based on the priority associated with the definite obstacle ID. For example, the device may be (pre) configured with a set of SRSp configuration parameters dependent on each priority level. If the priority is a high priority the set of resources may be determined to be a first set of resources (e.g., higher resources). If the priority is a low priority, the set of resources may be determined to be a second set of resources (e.g., lower resources). The set of resources (e.g., a resource in the set of resources) may be based on a number of detected obstacles and/or a number of obstacles with a respective priority above a priority threshold.

In examples, the set of resources may be based on an association rule, for example, which may associate a (e.g., each) priority level with a set of SRSp configurations (e.g., comb value, bandwidth). Based on the determined priority for the detected obstacle, the device may determine which set of SRSp configurations to use for estimation.

The device may perform a measurement associated with a transmission of a SRSp in the set of resources. In examples, performance of this measurement may incorporate more precise allocation of SRSp beams (e.g., narrower spatial direction and/or coverage) compared to the previous positioning transmission associated with obstacle sensing. For example, the measurement associated with a transmission of a SRSp in the set of resources may have a higher resolution for ToF and/or doppler frequency (e.g.,. due to a known angle of departure (AoD) and coverage angle and/or allocation of large time and frequency resources with the SRSp beams with small beamwidths in a specific direction).

In examples, improved accuracy/precision of the measurement may allow the device to resolve and identify multiple obstacles with similar measurements in the area (e.g., that may have be associated with one definite obstacle ID due to erroneous detection). If multiple obstacles are located with the same obstacle ID, the device may reassign temporary obstacle IDs to the obstacles and associated the measurement with it.

The device may determine an estimated location associated with the obstacle based on the measurement. For example, the device may transmit the configured SRSp resources in the set of resources and may receive the reflected resources back from the obstacle. The device may measure the ToF, RSRP, and/or the doppler frequency from the received resources and use these measurements to locate the obstacle. In examples, device may estimate the absolute position of the detected obstacle (e.g., if the device knows its location coordinates). In examples, the device may estimate a relative location of the detected obstacle with respect to the device (e.g., if the device does not know its own location).

The device may send estimated location information associated with the obstacle, for example to the network device. The estimated location information associated with the obstacle may indicate the definite obstacle ID, the estimated location, and/or the priority associated with the obstacle. The WTRU may receive configuration(s) (e.g., configuration information) for obstacle sensing. The WTRU may receive the configuration(s) from a network (e.g., a network device, such as a location management function (LMF) or base station, etc.). The configuration(s) (e.g., configuration information) may indicate one or more of the following: SRSp resource set(s), time and frequency resource(s), periodicity, a reference signal received power (RSRP) threshold, and/or a time of flight (ToF) threshold from a network. The WTRU may receive an indication (e.g., from the network) to initiate sensing (e.g., a sensing procedure). The WTRU may start/send SRSp transmission(s) (e.g., for obstacle detection, for example associated with a detection stage). The SRSp transmission may be started according to a configured order of transmission (e.g., beam sweeping) for object detection. In examples, the indication to initiate the sensing may include a time threshold and a timer may be started associated with starting the sensing (e.g., starting the sensing procedure, for example starting SRSp transmission). The WTRU may make (e.g., take, perform, etc.) measurements (e.g., RSRP, ToF, doppler shift) from received SRSp(s) (e.g., reflected SRSp(s). The WTRU may detect multiple obstacles that may be indicated by multiple varied measurements (e.g., measurement groups). The conditions for detecting multiple obstacles may be based on multiple measurements being above a threshold (e.g., for the measured SRSp(s), for example the measurements associated with the reflected SRSp(s)). The WTRU may label a detected obstacle with a temporary obstacle ID (e.g., assign a respective temporary obstacle ID to each respective detected obstacle) and may associate the measurements to the temporary obstacle ID (e.g., associate respective measurement(s) to a respective temporary obstacle ID). The WTRU may report the temporary obstacle ID(s) and associated measurements to the network.

The WTRU may receive one or more of the following from the network (e.g., an indication of one or more of the following): a definite obstacle ID(s); an association of a definite obstacle ID(s) to a temporary obstacle ID(s), for example, an association of a respective definite obstacle ID to a respective temporary obstacle ID (e.g., reported by the WTRU to the network)); or a priority associated with each definite obstacle ID (e.g., a respective priority associated with each respective definite obstacle ID). In some examples, an association of a definite obstacle ID(s) to a temporary obstacle ID(s) may be indicated if a detected obstacle with the temporary obstacle ID(s) is being tracked by the network.

The WTRU may perform location estimation of detected obstacle(s) according to a priority level (e.g., an indicated priority level) per detected obstacle. The WTRU may determine configuration(s) (e.g., determine SRSp resources from the same or different resource set(s) corresponding to the triggering direction, time, frequency, periodicity, and/or the like) for estimation. For example, the WTRU may determine and/or associate a set of these resources to each obstacle depending on the indicated priority level per detected obstacle (e.g., associate a respective set of the resources to each respective obstacle, for example associated with each respective temporary obstacle ID and/or definite obstacle ID). The resources for obstacle detection may be continued with a previous configuration, reconfigured with a different time allocation, reconfigured with a different frequency allocation, and/or terminated during the estimation phase. For example, the WTRU may determine to terminate sensing, based on a timer reaching a timer threshold.

The WTRU may make measurements per obstacle (e.g., as described herein using SRSp transmission(s)), may estimate the location of the obstacle(s), and/or may associate the obstacle ID(s) (e.g., temporary obstacle ID(s) and/or definite obstacle ID(s)) with the respective estimated locations and/or the indicated priorities. The WTRU may (e.g., for an obstacle) report the definite obstacle ID, the associated estimated location, and/or the priority to the network. For example, the WTRU may report a respective definite obstacle ID and a respective estimated location and respective priority associated with the respective definite obstacle ID (e.g., the WTRU may report to the network: a first definite obstacle ID and a first estimated location and first respective priority associated with the first definite obstacle ID; a second definite obstacle ID and a second estimated location and second respective priority associated with the second definite obstacle ID; etc.).

Feature(s) associated with determining initial configuration(s) for sensing, such as object sensing, are provided herein.

A WTRU may send a request for a SRSp configuration to a network entity (e.g., a network device, such as a location management function (LMF), or base station, such as a gNB). A SRSp configuration may configure reference signals to the WTRU. The request for a SRSp configuration may be sent in an uplink physical channel (e.g., a physical uplink shared channel (PUSCH) or a physical uplink control channel (PUCCH)). For example, the request may be sent via higher layer signaling, such as a medium access control-control element (MAC-CE) or a radio resource control (RRC) message. For example, the request may be sent via LTE positioning protocol (LPP) message(s).

Feature(s) associated with configuration for SRSp transmission are provided herein.

The WTRU may receive a SRSp configuration(s) (e.g., configuration information) from the network (e.g., network entity, such as a LMF or a base station, such as a gNB). The configurations may comprise one or more of the following: an SRS resource set ID, an SRS resource ID list, time configurations, frequency configurations, repetition configurations, or other configurations.

A SRSp configuration may comprise a time configuration, which may comprise one or more of: a slot offset relative to the triggering downlink control information (DCI), a starting symbol position, or a number of symbols.

A SRSp configuration may comprise a frequency configuration, whichmay comprise one or more of: comb offset values, cyclic shift values, a starting resource element (RE) position in frequency, or a number of RBs.

A SRSp configuration may comprise a repetition configuration, which may comprise one or more of: resource type (e.g., aperiodic, semi-persistent, periodic), or resource set periodicity for periodic and semi-persistent types.

A SRSp configuration may comprise other configuration(s), such as power control configuration(s) (e.g., default transmission power) and/or pathloss configuration(s) associated with a reference signal (e.g., a downlink positioning reference signal (DL-PRS), a synchronization signal block (SS-block).

Features associated with sensing assistance and capability information are provided herein.

The WTRU may receive sensing assistance information from and/or exchange capability information with a network. These messages and exchanges may take place semi-statically (e.g., via a LPP or RRC message). Transfer of sensing assistance information and/or capability information may be initiated, for example by a request by the network, or sent uninitiated.

The WTRU may receive sensing assistance information from the network. Sensing assistance information may comprise one or more of spatial information of the configured SRSp resource sets, resources including the angles (e.g., azimuth, zenith), or beamwidth.

The WTRU and the network may exchange capability information. A message (e.g., a capability message, such as a capability information message) may include (e.g., indicate) one or more of the WTRU's full duplexing capabilities, the WTRU's measurement capabilities, or the WTRU's reporting capabilities. In examples, a WTRU may send its maximum sensing range, the sensing time, doppler frequency resolutions, and/or the like.

The WTRU's full duplexing capabilities may include one or more of: whether simultaneous transmission and reception of wireless signals is applicable in the same frequency including sub-band overlapping or non-overlapping cases; parameter(s) related to necessary time gap for the transmission/reception (Tx/Rx) switching; parameter(s) related to antenna information (e.g., a number of antenna panels, antenna groups, and/or group of antenna ports applicable for the simultaneous Tx/Rx).

The WTRU's measurement capabilities may include the ability to measure doppler frequency shift, a maximum sensing range, a maximum sensing time resolution, a maximum doppler resolution, and/or the like.

The WTRU's reporting capabilities may include the ability to report measurements corresponding to a maximum number (N) of obstacles, the ability to report doppler frequency shifts, the ability to report the WTRU's position and/or orientation periodically, the ability to report the WTRU's position and/or orientation aperiodically, and/or the like.

The WTRU may send its maximum sensing range (e.g., a maximum sensing range of the WTRU), the sensing time, doppler frequency resolutions, and/or the like as the capability information.

The WTRU may determine and/or report its maximum sensing range, for example based on the configured and/or determined transmission power. In examples, the WTRU may determine its maximum search range based on the association between transmission power and maximum sensing range. For examples, the WTRU may determine that if the transmission power is N dBm, the maximum sensing range may be X meters based on (pre) configured association rules. The WTRU may determine transmission power based on configuration, configured downlink pathloss reference signal, and/or transmission power used for data communication (e.g., transmission power determined for PUSCH, PUCCH, SRSp, SRS).

The WTRU may determine and/or may report its maximum time resolution (e.g., Y ns). The maximum time resolution may depend on an allocated bandwidth for sensing (e.g., see equation (1)).

The WTRU's maximum time resolution may depend on the ability of the WTRU to process (e.g., compute FFT) large frequency domain samples. The maximum time resolution may depend on the available energy and/or the computation resources of the WTRU. The WTRU may have an improved sensing time resolution based on its ability to oversample the received SRSp resources. An improved sensing time resolution may increase complexity at the WTRU and/or depend on the capability of the WTRU.

The WTRU may determine and/or report its maximum doppler resolution capability (e.g., Z Hz). As seen in equation (2), the WTRU's maximum doppler shift resolution may depend on the number of orthogonal frequency-division multiplexing (OFDM) symbols used in a (e.g., each) measurement occasion. The WTRU's maximum doppler resolution capability may depend on the WTRU's complexity and/or capability.

The WTRU may send sensing capability information to the network uninitiated (e.g. without an indication from the network). Sensing capability information may be sent, for example, based on a determination (e.g., by the WTRU) that the sensing capability information is desired at the network. For example, the WTRU may send sensing capability information to the network if the WTRU determines one or more of the following may assist the network (e.g., if the WTRU determines that the sensing capability information is desired at the network): the full duplex capability information; the maximum sensing range information; the sensing time resolution information; the sensing doppler resolution information; the capability of the WTRU to report the measurements corresponding to the maximum number of N obstacles; the capability of the WTRU to report its current position; or the capability of the WTRU to report its current orientation.

For example, the WTRU may determine the full duplex capability information may assist the network in allocating the monostatic sensing configurations (e.g., SRSp resources) to the WTRU. For example, the WTRU may determine the maximum sensing range information may assist the network in choosing the sensing configuration (e.g., SRSp resources) for the WTRU. For example, the WTRU may determine the maximum sensing range and the sensing time/doppler resolution information can assist the network in allocating the sensing configurations (e.g., SRSp resources) for the WTRU.

The WTRU may be configured to report (e.g., have the capability to report) the measurements corresponding to the maximum number of N obstacles, its current position, and/or its current orientation. The WTRU may determine its capability to report the measurements corresponding to the maximum number of N obstacles, or its ability to reports its current position and/or orientation may assist the network in allocating the sensing configurations (e.g., SRSp resources) for obstacle detection to the WTRU.

Feature(s) associated with sensing measurements and resolutions are provided herein.

The RSRP may be defined as the power of the received SRSp resources. The ToF may be defined as the propagation duration between the transmitter and receiver. For a monostatic sensor, the ToF may represent the two-way range between the WTRU and the obstacle. The ToF may be measured through transmit and receive time stamps. For example, the WTRU may measure the time stamps in terms of symbol index, slot index, frame index, and/or the like. The time stamps may be absolute or relative. An absolute time may refer to the exact transmit and receive time of the SRSp resources (e.g., Tx time: 5th slot, Rx time 6th slot, ToF=Rx timestamp-Tx timestamp=1 slot). A relative time may refer to the difference in transmit and receive time of the SRSp resources (e.g., ToF=1 slot).

The resolution and/or the accuracy of the absolute and/or relative time measurements may depend upon the sensing time resolution ΔToF. The sensing time resolution may be written as:

$$Δ ToF = \frac{1}{2 S Δ f} = \frac{{T}_{S}}{2 S} \qquad ( 1 )$$

Where, ΔF may be the subcarrier spacing used and S may be the number of active subcarriers where the SRSp signals are transmitted. Equation (1) may signify that the SRSp signal may be sampled 2S times for a symbol duration (e.g., every OFDM symbol duration). This may imply that any two obstacles may be detected if the difference in their measured ToF is greater than ΔToF.

The WTRU may measure a shift in measured frequency due to the mobility of the obstacle. The doppler resolution, may be formulated as:

$$Δ {f}_{d} = \frac{1}{{KT}_{S}} \qquad ( 2 )$$

Where, K may be the total number of OFDM symbols allocated and T_{S} may be the OFDM symbol duration. This may imply that any two obstacles may be resolved if their measured doppler frequency is greater than Δf_{d}.

Feature(s) associated with WTRU position and orientation reporting are provided herein.

The WTRU may be configured to report its position and/or orientation to the network. Position information of the WTRU may be used to estimate the absolute position of the obstacle (e.g., as opposed to the relative location which may otherwise be estimated). Orientation information of the WTRU may be used to monitor angle of departure (AoD) of the SRSp resource with respect to a reference direction. The WTRU may report the orientation in degrees or radians.

The WTRU may be configured (e.g., by the network) to transmit SRSp resources for estimating its location. Transmission configurations (e.g., for location estimation) may be periodic and/or aperiodic in nature. The WTRU may be configured with time and frequency resources indicating when the WTRU should transmit the SRSp resources for positioning. The SRSp beams transmitted by the WTRUs may be measured by network devices (e.g., gNBs) in the configured time and frequency resources to resolve the WTRU position. The WTRU may receive its position (e.g., estimated position) from the network.

The WTRU may be configured to report its position using RAT independent methods (e.g. using GPS). The WTRU may report its position upon detecting any change in position between two measurement occasions. The WTRU may determine a change in position based on the distance measurement of the WTRU positions in the two measurement occasions being above a (pre) configured threshold.

The WTRU may be configured to report its orientation using RAT independent methods (e.g. using inertial sensors). The WTRU may report its orientation upon the request of the network and/or upon detecting any change in its orientation. This change in the orientation may be determined based on the difference of orientation between two measurement occasions above a (pre) configured threshold.

Feature(s) associated with initiation of a sensing process are provided herein.

The WTRU may receive an indication from the network, for example through a WTRU dedicated DCI, MAC-CE, RRC, and/or LPP message. The indication may indicate to initiate a sensing process. This indication may be triggered by the WTRU or sent (e.g., independently) by the network.

The WTRU may trigger the sensing process due to implicitly sensing obstacles in its vicinity. This implicit sensing may be a result of one or more of degrading positioning performance due to blockages between the WTRU and one or more TRPs, or degrading communication performance due to blockages between the WTRU and a TRP.

The WTRU may determine degrading positioning performance are due to blockages between the WTRU and the TRPs based on one or more of the following conditions: the WTRU determines a change in status of a TRP from LoS to NLoS; the WTRU determines a decrease in the measured RSRP values of the RS (e.g., PRS, SRSp) below a (pre) configured threshold; the WTRU determines an increase in the measured ToF values above a (pre) configured threshold; the WTRU determines a change in the measured doppler shift above a (pre) configured threshold; the WTRU determines additional multipath components with additional resolved measurements with RSRP, ToF, and/or doppler shift above a (pre) configured threshold; the WTRU receives multiple spatially non-overlapping DL-PRS resources with distinct AoDs with RSRP above a (pre) configured threshold; or the WTRU does not receive an RS in a configured time.

The WTRU may determine degrading communication performance due to blockages between the WTRU and a TRP based on one or more of the following conditions; the WTRU receives the RS (e.g., CSI-RS, SSB, DM-RS, and/or the like) with a drop in RSRP above a (pre) configured threshold; the WTRU determines a change in the SNR/SINR in the communication channel above a (pre) configured threshold; the WTRU determines no LoS channel (e.g., a change in the measured channel statistics (e.g., Rician channel distribution)); the WTRU receives multiple re-transmission requests above a (pre) configured threshold; or the WTRU does not receive the RS for communication in a scheduled time (e.g., msg2, msgB after the WTRU sends a PRACH).

The network may trigger the sensing process based on the WTRU's estimated location and/or approximate obstacle's location. The obstacle's location may be predetermined at the network or may be reported by other WTRUs in the vicinity.

The WTRU may report its position periodically and/or may transmit SRSp symbols periodically. Based on the WTRU position, the WTRU may receive a message from the network to trigger the sensing process, for example, based on the network detecting that the distance between the WTRU and the detected obstacle may be below a (pre) configured threshold.

Feature(s) associated with expected sensing range are provided herein.

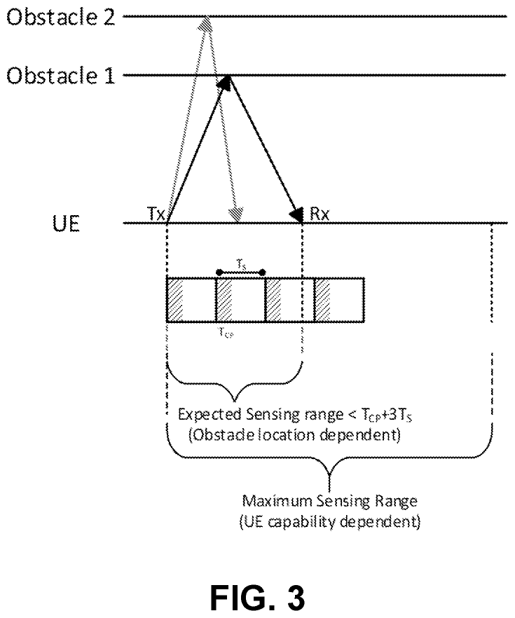

The WTRU may be configured to estimate the expected sensing range. In examples the sensing range may be approximate. The expected sensing range may be different from a maximum sensing range, for example, because the expected sensing range may be a function of the approximate obstacle location. This information may be used to determine SRSp transmission pattern without inter-symbol interference (see e.g., FIG. 3).

The sensing range may be a continuous value and/or a granular value. Granular values may be defined as n=0,1,2, . . . , N, where n may be related to the sensing range with the expression

$${d}_{r a n g e} = \frac{c ( {T}_{C P} + n {T}_{s} )}{2} .$$

In this expression, c may be the speed of light and T_{CP} and Tₛ may represent the CP time and the OFDM symbol time (with CP).

The WTRU may determine the expected sensing range before the initiation of the sensing process (e.g. during the communication procedure or the positioning procedure). In examples the WTRU may determine the sensing range based on one or more of the following: blockage of the LoS positioning link (e.g., changing TRP status from NLoS to LoS, no RS reception, etc.); blockage of the LoS communication link (e.g., total number of retransmission requests above a threshold); additional measurements indicating additional detected multipath component(s) (e.g., additional ToF value(s) below a threshold and/or additional RSRP value(s) above a threshold); the delay spread of the channel (e.g., the delay spread of the channel satisfying a threshold); or coherence bandwidth of the channel (e.g., the coherence bandwidth of the channel satisfying a threshold).

The observation of blockage during the communication or the positioning procedure may signify that the obstacle is in between the WTRU and the TRP.

Feature(s) associated with sensing window configuration are provided herein.

The WTRU may be configured with a time window for the sensing procedure. In examples because sensing involves dedicating time and frequency resources and/or energy otherwise used for communication or positioning purposes, the time window may limit the resources allocated for sensing.

The sensing window may be characterized by one or more of the following parameters: start time; end time; or duration. Start and/or end times may be defined in terms of symbol index, slot index, frame index, absolute time, or relative time with respect to a reference point. The reference point for the relative time may be the time instance when the WTRU requests for configurations for the sensing process and/or the time instance when the WTRU receives the network trigger (e.g., through DCI/MAC-CE) for initiation of the sensing process. Durations may be defined in terms of number of symbols, slots, frames, subframes, seconds.

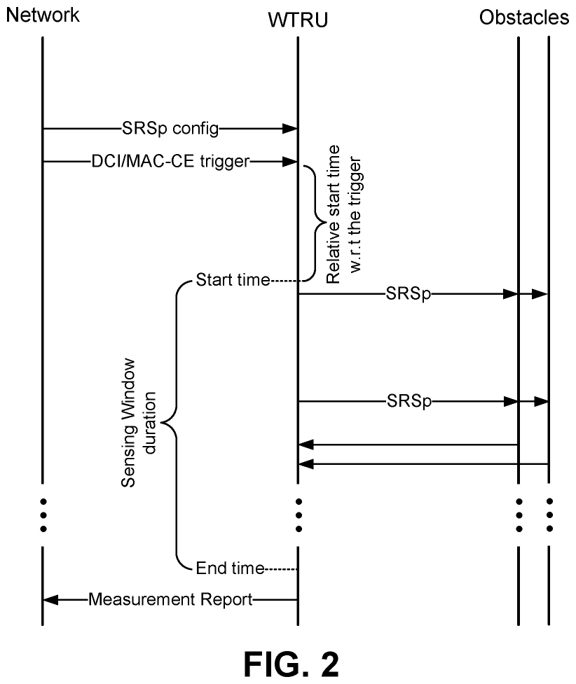

FIG. 2 depicts an example sensing process and example configurations of a sensing window (e.g. a DCI/MAC-CE triggered sensing window).

Sensing window parameters (e.g. start time, end time, duration, reference point for the relative time) may be configured by the network. The total duration of the window allocated for sensing may be based on one or more of: positioning requirements, communication requirements, the WTRU capabilities, the communication performance of the WTRU, or the positioning performance of the WTRU.

A short sensing window may be configured. For example, a short sensing window may be configured based on one or more of the following conditions: higher priority to the DL or UL communication or positioning RS (e.g., PDSCH, PUCCH, PRS, SRSp etc.); the WTRU moving at a velocity above a threshold (e.g., 50 km/hr may correspond to a 10 second sensing window duration); a maximum sensing range being below a (pre) configured threshold; total available energy at the WTRU being below a (pre) configured threshold; or a low severity of the blockage due to obstacles. In examples, low severity of the blockage may be associated with (e.g., indicated by) the positioning performance (e.g., measured RSRP) being below a (pre) configured threshold and/or the communication performance (e.g., measured SNR) being below a (pre) configured threshold.

Feature(s) associated with the detection phase are provided herein. For example, feature(s) associated with SRSp configuration for the detection phase are provided herein.

The WTRU may (e.g., after receiving the SRSp configurations and the sensing window configurations) receive an indication from the network to initiate the sensing detection phase. The WTRU may be configured with SRSp resources for the detection phase. The resources for the detection phase may be based on (e.g., depend upon) the duration of the configured sensing window.

The WTRU may be allocated frequent and/or dense detection resources. Frequent and/or dense detection resource allocation may enable quick obstacle detection. Thresholding may be used to determine if frequent and/or dense configurations are considered. A frequent and/or dense resource configuration may be used if the allocated sensing window is below a threshold, for example, due to the WTRU moving with a high velocity, the WTRU having priority to other UL and DL channels (e.g., PUSCH, PDSCH), and/or the like.

In examples, frequent and/or dense configurations may be characterized by periodic or semi-persistent resources with one or more of: short periodicity, dense allocation of the sensing resources (e.g., comb-2 configurations), or allocation of large bandwidth and number of symbols for sensing.

The WTRU may be allocated less frequent and/or sparse resources. Less frequent and/or sparse detection resource allocation may enable efficient obstacle detection over a longer period of time. Thresholding may be used to determine if less frequent and/or sparse configurations are considered. A less frequent and/or sparse configuration may be considered if the WTRU is configured with a longer sensing window, for example, due to the WTRU being static or moving with a low velocity, high priority to sensing, and/or the like.

In examples, less frequent and/or sparse configurations may be characterized by one or more of periodic or semi-persistent resources with long periodicity, sparse allocation of the sensing resources (e.g., comb-8 configurations), or allocation of small bandwidth and number of symbols for sensing.

The WTRU may be configured to determine the sensing window based on the SRSp configurations from the network. The WTRU determining the sensing window may reduce signaling overhead associated with receiving the sensing window configurations. Sensing configurations may be based on the duration of the time window. For example, the WTRU may be configured with association rules between the parameters of the sensing window and the SRSp configurations.

Association rules between the parameters of the sensing window and the SRSp configurations may include one or more of the following. The starting slot of the SRSp configurations may be associated with the start time of the sensing window (e.g., start time of sensing window=starting slot of SRSp-A slots). The sparsity of the configurations may be associated with the sensing duration (e.g., Comb-2 configuration may be associated with a longer sensing window compared to Comb-8). The resource set periodicity may be associated with the sensing duration (e.g., a periodicity of 64 slots may be associated with a shorter sensing window compared to a periodicity of 320 slots). The allocated bandwidth may be associated with the sensing duration (e.g., a bandwidth of 72PRB may be associated with a shorter sensing window when compared to a bandwidth of 24PRB).

WTRU configurations may (e.g., also) be dependent on the estimated sensing range. For example, if the sensing range is large (e.g., spanning multiple OFDM symbols), the WTRU may be configured with a sparser SRSp resources (e.g., comb-12 configurations) to avoid inter symbol interference.

FIG. 3 depicts an example SRSp configuration that may be based on the estimated sensing range. As depicted in FIG. 3, the maximum estimated sensing range may be c (T_{CP}+3 T_{S}). In examples, the inter-symbol interference free SRSp allocation may be to allocate the SRSp configurations in a way to ensure at least 3 empty symbols after each transmission for each subcarrier. Such configurations may be achieved with comb-4 or comb-8 configurations.

Feature(s) associated with SRSp transmission, reception, and measurement are provided herein.

The WTRU may transmit the configured SRSp resources at an indicated time. In some examples where the WTRU may be equipped with full duplex capabilities, the WTRU may transmit and receive the SRSp resources using separate but co-located transmit and receive antenna panels.

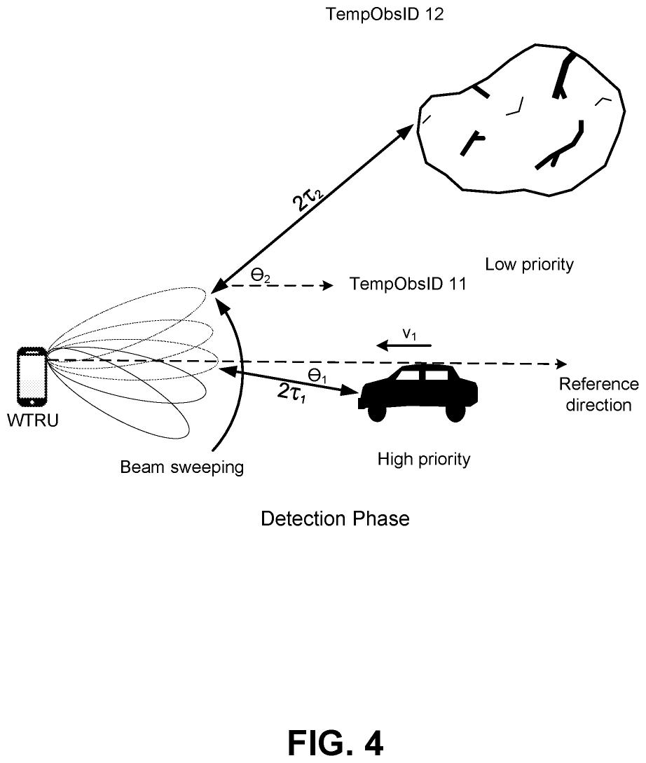

FIG. 4 depicts an example of beam sweeping, obstacle detection, temporary obstacle ID allocation, and obstacle prioritization. The WTRU may be configured with a pattern of beam transmission (e.g., beam sweeping as illustrated in FIG. 4) for the detection phase.

The WTRU may define and send (e.g., transmit) its default SRSp configuration for the detection phase. This default condition may be triggered, for example, when the WTRU does not receive the configurations by the network (e.g., within an indicated time). The default configuration may include one or more of: a beam transmission pattern (e.g., beam sweeping); time resources (e.g., number of symbols, starting symbol position, etc.); frequency resources (e.g., number of RBs, starting RE position, etc.); or periodicity (e.g., type, number of repetitions).

The WTRU may receive the transmitted SRSp symbols in the same symbol or in the subsequent symbols. The WTRU may receive a back signal with a single bounce from the obstacle in the direct LoS path, with multiple bounces through multiple obstacles in the NLoS path, and/or through ground reflections (e.g., as a cluster).

The WTRU may measure RSRP, ToF, and/or doppler shift in a measurement occasion (e.g., each measurement occasion). These measurements may be indicative of the distance between the WTRU and an obstacle and/or a velocity of the obstacle. For example, a higher RSRP may correspond to a reflection from a nearby obstacle. For example, a lower ToF measurement may correspond to a measurement from the reflection corresponding to a nearby obstacle. For example, a large positive doppler shift may be indicative of the obstacle moving towards the WTRU with high velocity. For example, a large negative doppler shift may be indicative of the obstacle moving away from the WTRU with large velocity.

The WTRU may store the measured values for the RSRP, the ToF, and/or the doppler shift associated with the received SRSp resources for a measurement occasion (e.g., each measurement occasion).

Feature(s) associated with measurement groups are provided herein.

The WTRU may group together the multiple SRSp resources and the measurements associated with the multiple SRSp recourses, for example, based on a determination of whether or not the reflections are from the same obstacle or not. Multiple SRSp resources may reflect from the same obstacle and arrive at the receiver in a LOS path or a NLoS path.

The WTRU may determine a group of SRSp resources, for example, based on one or more of the following thresholds/conditions: multiple SRSp resources with equal RSRP, ToF, and/or doppler shift measurements being within a (pre) configured error threshold; a RSRP difference between two SRSps being within a (pre) configured threshold, an equal angle of arrival (AoA) of the SRSp resources being up to a (pre) configured threshold, an AoA difference between two SRSp being within a (pre) configured threshold, and/or subsequent spatial beams with similar AoDs of the SRSp resources (e.g., beams with AoDs 20deg, 25deg and 30deg) being within a (pre) configured similarity threshold.

In examples, grouping of SRSp resources based on metrics may be done up to a (pre) configured error tolerance threshold. The variances in the RSRP, ToF, doppler shift, and/or the AoA may arise from sources, such as imperfect resolutions for estimating the metrics, additive noise, and/or the like. The SRSp with different AoDs may reflect off a same obstacle (e.g., as different beams with different AoDs may overlap with each other).

A measurement group (e.g., each measurement group) may be characterized by one or more of the following: SRSp resource ID(s); (average) RSRP, (average) ToF, and/or (average) doppler shift measurements corresponding to the SRSp resource ID(s); (average) AoA corresponding to the received SRSp resource ID(s); AoD coverage angle corresponding to the SRSp resource ID(s); or a LoS/NLoS indicator (e.g., hard indicator (0 and 1) or soft indicator (0, 0.1, . . . , 1).

The WTRU may associate different measurements (e.g., RSRPs, ToFs, doppler shifts, AoAs) to a group (e.g., measurement group). The measurements associated with a measurement group may be the averaged and/or median values of RSRPs, ToFs, doppler shifts, and/or the AoAs. These average and/or the median values may be computed as an average or median of the measurements from the SRSp resource within a group.

The WTRU may determine the AoD and coverage angle for each measurement group based on the corresponding SRSp resources. The WTRU may obtain the AoD for the obstacle by determining the averaged AoD of the unique SRSp resources in the group and/or the median AoD of the unique SRSp resources in the group.

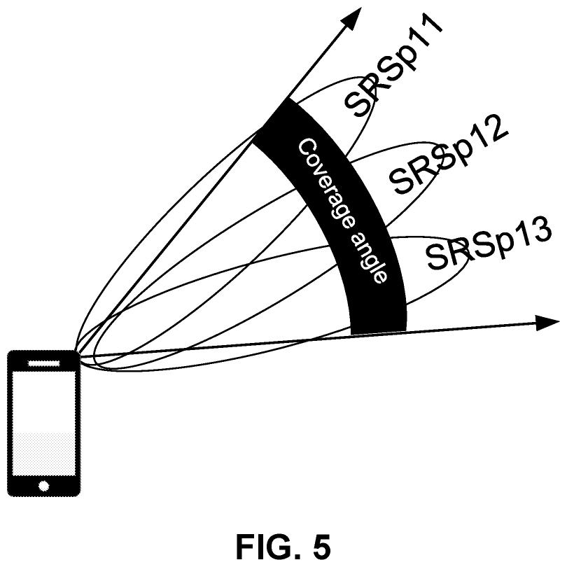

FIG. 5 depicts an example of SRSp resources and a coverage angle within a measurement group. The WTRU may obtain a coverage angle of an obstacle in the group as the aggregated beamwidth of the SRSp resources with unique AoDs in the group, as depicted in FIG. 5. As illustrated in FIG. 5, the AoD for the measurement group may be considered as the mean or median of the SRSp resources (e.g., SRSp 11-13). The coverage angle may be the aggregated beamwidth of the SRSp resources (e.g., the coverage angle depicted in FIG. 5).

Multiple measurement groups may comprise the same SRSp resources, e.g., as a result of multiple bounce reflection through other obstacles and/or surfaces.

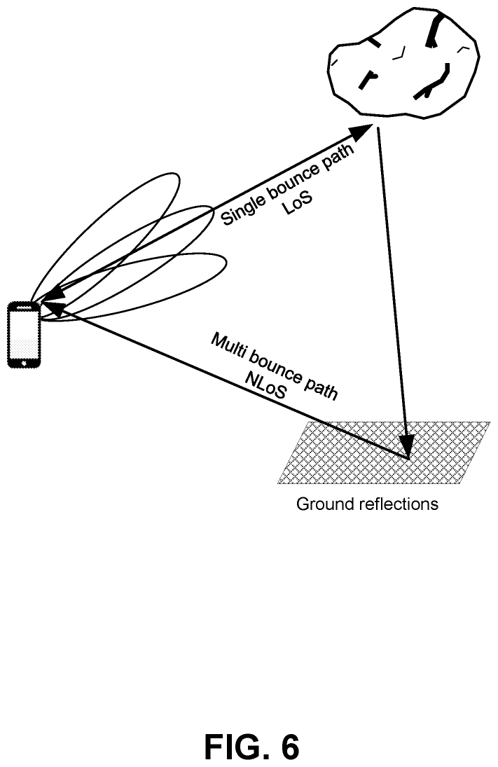

FIG. 6 depicts examples of a LOS measurement path and a NLoS measurement path. The WTRU may label a formed measurement group (e.g., each formed measurement group) as LoS or NLoS, as illustrated in FIG. 6. The measurement groups that correspond to the SRSp received in a direct LoS path may be labelled as LoS measurements groups. The measurement groups that correspond to the SRSp received through multiple bounce paths (e.g., through multiple obstacles or ground reflections) may be labelled as NLoS measurement groups. The LOS and NLoS labels may be specified as a hard indicator (e.g., 0 and 1) or a soft indicator (e.g., 0, 0.1, . . . , 1). Labelling may reduce the ambiguity in obstacle detection (e.g., due to multiple bounce paths).

The condition(s) for the WTRU to identify a group of measurements as LoS may comprise one or more of the following: the (e.g., average) AoD of the SRSp resources in the measurement group is the same as the (e.g., average) received AoA; the (e.g., average) ToF of the measurement group is shorter compared to the groups with overlapping SRSp resources; the (e.g., average) RSRP is higher compared to the measurement groups with overlapping SRSp resources; the (e.g., average) RSRP measurement of the measurement group is above the (pre) configured threshold; or the (e.g., average) ToF measurement of the measurement group below the (pre) configured threshold. The WTRU may label measurement groups not labelled as LoS as NLoS (e.g., the rest of the measurement groups).

Feature(s) associated with the event of obstacle(s) detection are provided herein.

The WTRU may detect multiple obstacles in the environment, e.g., based on the measurement groups of the received SRSp resources. The conditions for obstacle detection may include one or more of (e.g., the WTRU may consider that an obstacle is detected based on one or more of the following conditions being satisfied): the measurement group(s) are labelled as LoS, a difference between the (e.g., average) measured RSRP in a previous measurement occasion and a current measurement occasion of the measurement group is above a (pre) configured threshold; a difference between a (e.g., average) measured ToF in a previous measurement occasion and a current measurement occasion of the measurement group is above a (pre) configured threshold; a measured absolute (e.g., average) doppler shift of the measurement group is above a (pre) configured threshold; or a difference between the (e.g., average) measured doppler shift in a previous measurement occasion and a current measurement occasion of the measurement group is above a (pre) configured threshold.

Feature(s) associated with fallback behavior in case of no obstacle detection are provided herein.

In examples, a sensing timer may reach a threshold without an event of obstacle detection. The WTRU may report a lack of an event (e.g., “No Obstacle Detection” message). The WTRU may request for additional sensing window (e.g., start time, end time, duration, etc.) in order to continue the sensing process. The WTRU may decide to terminate the sensing procedure and continue the communication procedure and/or localization procedure.

The WTRU may decide to request for an additional sensing window if the WTRU determines low priority levels for communication and/or localization procedures determined by the WTRU. The WTRU may decide to request for an additional sensing window if the WTRU has a large available resource (e.g., energy, time, frequency) for sensing. The WTRU may (e.g., determine to) terminate the sensing procedure, for example, if the above conditions are not fulfilled.

Feature(s) associated with allocation of the obstacle IDs are provided herein.

The WTRU may generate and/or label a detected obstacle (e.g., each detected obstacle) with a unique temporary obstacle ID (e.g., as illustrated in FIG. 4). A temporary obstacle ID (e.g., each temporary obstacle ID) may be unique to the WTRU. For example, the WTRU may include its WTRU ID in the temporary obstacle ID to indicate a reference. A (e.g., each) temporary obstacle ID may be associated with corresponding SRSp resource ID(s), measurement(s), AoD, and/or the coverage angle.

The WTRU may be configured with a group of temporary IDs by the network (e.g., LMF, gNB). The group of temporary IDs may comprise a (pre) configured number (N) of temporary IDs. In examples, the WTRU may be configured with the number (N) of temporary IDs by the network. In examples, the WTRU may determine the number (N) of temporary IDs as a function of configurations (e.g., PRS configuration, sequence ID, WTRU ID such as RNTI).

Feature(s) associated with reporting in the detection phase are provided herein.

The WTRU may report a detected obstacle(s) to the network. The WTRU may report one or more of the following, e.g., per detected obstacle, in the event of obstacle(s) detection: a temporary obstacle ID or an obstacle ID; an RSRP (e.g., average RSRP), ToF, and/or doppler shift measurement(s) for the measurement group(s) associated with the obstacle ID; an associated AoD; an associated coverage angle; SRSp resource(s) and/or SRSp resource ID(s) associated with the detected obstacle; SRSp resource set(s) and/or SRSp resource set ID(s) associated with the detected obstacle; any other information related to SRSp resource(s) associated with the detected obstacle; or a time stamp (e.g., expressed in terms of symbol index, slot index, frame or subframe index, absolute time, relative time with respect to a reference time).

The WTRU may determine an obstacle ID from a configured list of temporary IDs. The WTRU may be configured with a selection rule for selecting the obstacle ID from the network. For example, the WTRU may assign the obstacle ID based on the lowest obstacle ID value in the list of temporary IDs.

The WTRU may report information and/or attributes not related to the obstacle. The WTRU may report one or more of the total number of NLoS measurement groups, SRSp resource(s) or SRSp resource ID(s) associated with NLoS measurement group, SRSp resource set(s) or SRSp resource set ID(s) associated NLoS measurement group, or (e.g., average) RSRP, ToF, and/or doppler shift measurements for rest of the groups with the associated LoS/NLoS ID.

A report by the WTRU may act as a trigger for the network to initiate an estimation phase.

The WTRU may be configured with reporting occasions and/or reporting periodicity (e.g., if periodic reporting or sensing is configured by the network). The WTRU may determine to transmit a measurement report (e.g., RSRP, AoA, ToF, ToA) after a configured duration (e.g., N slots), for example, after the WTRU receives SRSp.

Feature(s) associated with power control behavior are provided herein.

The WTRU may determine to increase transmission power by a (pre) configured amount if the WTRU does not detect Rx RSRP for transmitted SRSp or receive sufficient amount of Rx RSRP for transmitted SRSp. For example, if the WTRU receives SRSp with RSRP below a (pre) configured threshold during a (pre) configured time window (e.g., measurement window), the WTRU may increase transmission power by a (pre) configured amount (e.g., delta, offset). The WTRU may determine to increase transmission power by a (pre) configured amount if the WTRU does not receive SRSp during a (pre) configured time window. The WTRU may determine to increase transmission power at a (pre) configured number of occasions (e.g., N). The WTRU may determine to stop sensing if, after N occasions of power increase, the WTRU receives SRSp below a (pre) configured threshold.

In examples, one or more of the following may be performed. The WTRU may be configured with a SRSp configuration (e.g., spatial information, bandwidth), time window, delta, RSRP threshold, and/or N. An initialize power increase counter to may be set to 0. The WTRU may transmit the configured SRSp at the configured transmission power. If the WTRU receives SRSp whose RSRP may be below a configured RSRP threshold or if the WTRU does not receive SRSP within the configured time window, the WTRU may determine to increase the transmission power by delta. The power increase counter may be incremented by one. If the counter is less than N, the WTRU may transmit the configured SRSp at the reconfigured transmission power. Otherwise, the WTRU may perform a configured SRSp transmission (e.g., using different SRSp resource). If there are no other SRSps for transmission, sensing may be terminated.

Feature(s) associated with an estimation phase are provided herein.

The WTRU may be configured for an estimation phase by the network for locating the obstacle(s). The WTRU may receive definite obstacle ID(s) and priority (ies) associated with them for obstacle location estimation.

Feature(s) associated with providing a definite Obstacle ID are provided herein.

The WTRU may receive multiple unique definite obstacle IDs from a network (e.g., a network device such as a base station), each associated to the WTRU reported temporary obstacle ID (e.g., the WTRU may receive an indication of a respective definite obstacle ID associated with a respective temporary obstacle ID reported by the WTRU).

The WTRU may be configured (e.g., by the network) to allocate (e.g., associate) the definite obstacle ID to the obstacle. The WTRU may receive a database of the network tracked obstacles and unique definite obstacle IDs (e.g., from the network) for obstacle tracking and ID allocation. ID allocation may be based upon association of the reported measurements with other tracked obstacle(s) (e.g., an obstacle in a database) and/or new obstacle identification by the WTRU (e.g., an obstacle not in a database). In examples, tracked obstacles may be based on a database of the obstacles with their locations tracked by the WTRU and/or a database provided by the network to the WTRU with the tracked obstacles with their locations.

In instances where an obstacle has already been allocated a definite obstacle ID, the WTRU may just update the location of the obstacle in the database based on the sensing process. In instances where the WTRU determines the identification of a new obstacle, the WTRU may allocate the obstacle ID (e.g., allocate a temporary obstacle ID as described herein) and log it in the database.

The definite obstacle ID may be network generated and may not contain any reference to the WTRU.

In examples, if the WTRU receives a definite ID, the WTRU may report measurements associated with the definite ID and include the definite ID in the report.

Feature(s) associated with obstacle prioritization are provided herein.

The WTRU may receive a priority for obstacle location estimation from the network. This priority may be categorically represented (e.g., high, medium, low) or numerically represented (e.g., 0,0.1, . . . , 1 with 1 indicating the highest priority). A received priority (e.g., each received priority) may be associated with one or more definite obstacle ID(s) (e.g., each received priority may be associated with a respective one or more definite obstacle ID(s) received from the network). A priority (e.g., each priority) may indicate or be associated with resource(s) (e.g., an amount of resources) to be allocated for the obstacle location estimation (e.g., for performing measurements as described herein).

The priority for obstacle(s) (e.g., respective priority for a respective obstacle) may be determined and/or indicated by the WTRU. The WTRU may determine priority for each obstacle based on one or more characteristics associated with the obstacle. This prioritization may depend on one or more of the following factors associated with an obstacle: an estimated ToF (e.g., the distance between the WTRU and the detected obstacle), a measured RSRP, an estimated velocity of the obstacle, a relative direction of the movement of the obstacle, an absolute direction of the movement of the obstacle, or a communication or localization performance loss, etc. For example, the WTRU may use a combination of the above factors to decide and/or indicate the priority of the obstacle.

Priority determination by the WTRU may be performed and may include one or more of the following. The WTRU may, for example, allocate a high priority to an obstacle where one or more of the following conditions are present: the ToF between the WTRU and the detected obstacle is below a threshold, the velocity of the detected obstacle is above a threshold, or the RSRP for positioning or SNR for communication is below a threshold (e.g., which may imply blockage of the LoS positioning or communication link).

The WTRU may determine to associate (e.g., assign) a high priority to an obstacle if the velocity associated with the obstacle is greater than a configured threshold. If the velocity associated with the obstacle is less than or equal to the configured threshold, the WTRU may determine to associate a low priority to the obstacle.

The WTRU may determine to associate (e.g., assign) a low priority to an obstacle if the ToF associated with the obstacle is greater than a configured threshold. If the ToF associated with the obstacle is less than or equal to the configured threshold, the WTRU may determine to associate a high priority to the obstacle.

If an obstacle is moving away from the WTRU, the WTRU may determine to associate (e.g., assign) a low priority to the obstacle. If the obstacle is moving towards the WTRU, the WTRU may associate a high priority to the obstacle.

If uncertainty associated with the location of a detected obstacle is above a configured threshold, the WTRU may determine to associate (e.g., assign) a high priority to the obstacle.

If the WTRU detects an obstacle (e.g., a vehicle) with high velocity (e.g., 140 km/hr) in a small distance (e.g., 100 m) approaching the WTRU, the WTRU may prioritize the obstacle with high priority.

The WTRU may determine to associate and/or indicate a priority with an obstacle if the WTRU detects more than one obstacle.

The WTRU may report (e.g., to the network, for example LMF, gNB) priorities associated with detected or estimated obstacles (e.g., respective priority associated with respective one or more estimated obstacles).

Feature(s) associated with priority dependent SRSp configuration for the estimation phase are provided herein.

The WTRU may, based on reception of definite obstacle ID(s) and priority (ies) associated with the definite obstacle ID(s) (e.g., respective one or more definite obstacle ID(s) associated with a respective priority), determine to perform (e.g., perform) estimation of an obstacle's location based on the indicated priority (e.g., estimate a respective location of a respective obstacle associated with a respective definite obstacle ID and/or respective priority).

The WTRU may be configured (e.g., by the network) with SRSp resources including time, frequency, periodicity, and/or the like resource(s) for locating obstacles. The WTRU may associate the available SRSp resources and the available time and frequency resources with the priority of obstacles.

The WTRU may be (pre) configured with one or more SRSp configuration parameters (e.g., a set of SRSp configuration parameters). A set of SRSp configuration parameters may be dependent on each priority level (p) (e.g., a respective set of SRSp configuration parameters may be associated with a respective priority level). Configuration parameters may include one or more of the following: a minimum estimation time threshold Tₘᵢₙ(p) (e.g., in terms of number of symbols, slots, frames, subframes, seconds); a minimum estimation bandwidth threshold Bₘᵢₙ(p) (e.g., in terms of RE, PRB, Hz); a beamwidth of the SRSp resources θ(p); or a comb pattern (e.g., Comb-M) with M dependent on the priority level p. The set of beamwidth parameters may be selected based on the beamwidths corresponding to the configured resource sets (e.g., in terms of radians, degrees).

The WTRU may receive, from the network (e.g., a network device, such as a base station), configuration parameters as an equation or function with priority as a dependent variable or in a tabular form with different parameters associated with different priority levels.

The WTRU may be configured with an association rule which associates a priority level with a set of SRSp configurations (e.g., comb value, bandwidth). Based on the determined priority for the detected obstacle, the WTRU may determine which set of SRSp configurations (e.g., which set of SRSp resources) to use for location estimation.

The WTRU may self-determine a set of parameter(s) (e.g., the parameters listed above) for a priority level (e.g., each priority level), for example based on one or more of the following.

The WTRU may determine the minimum time threshold Tₘᵢₙ(p) based on a required velocity estimation accuracy for each priority level. In examples, the accuracy and/or the time threshold may be different for different priority levels.

The WTRU may determine the minimum bandwidth threshold Bₘᵢₙ(p) based on a required ToF estimation accuracy for each priority level. In examples, the accuracy and/or the bandwidth threshold may be different for different priority levels.

The WTRU may determine a set of beamwidth thresholds θ(p) (e.g., one for each priority level). Sensing with low beamwidths may allow for SRSp resource reception with high SNR and higher AoD resolution. Beamwidths may be associated with the different priority levels. For example, high priority obstacles may require a better accuracy measurement (e.g., a lower beamwidth).

The WTRU may determine a comb pattern for each priority level. A denser comb pattern (e.g., Comb-2 configurations) may be associated to a high priority level. A low priority level may be associated with a sparser comb pattern (e.g., Comb-8 configurations).

The WTRU may determine the above-mentioned parameters for different priority levels based on the energy available to the WTRU. For example, energy levels below a (pre) configured threshold may be associated with Tₘᵢₙ=0 and Bₘᵢₙ=0 for priority levels below a threshold indicating no estimation resource is allocated.

The WTRU may determine a number of obstacles (N) to which the WTRU may allocate resource(s) for location estimation. In examples, the number of obstacles may be less than or equal to the total number of detected obstacles. The WTRU may determine a large number (N) of obstacles based on one or more of the following conditions: a total unallocated/available sensing duration for the estimation phase is above a (pre) configured threshold (e.g., based on the current time and the sensing window stop time); a total available bandwidth is above a (pre) configured threshold; a total available energy at WTRU is above a (pre) configured threshold; a number of obstacles (e.g., with a respective priority above a threshold priority) is above a (pre) configured threshold; a minimum time threshold for each priority level is below a (pre) configured threshold; or a minimum bandwidth threshold for each priority level is below a (pre) configured threshold.

The WTRU may select a number of the highest priority obstacles from a list of total detected obstacles (e.g., after determining the number of obstacles to which the WTRU may allocate resources).

The WTRU may associate a set of resources (e.g., time, frequency, density, etc.) to each priority level (e.g., the WTRU may associated a respective set of resources to a respective priority level).

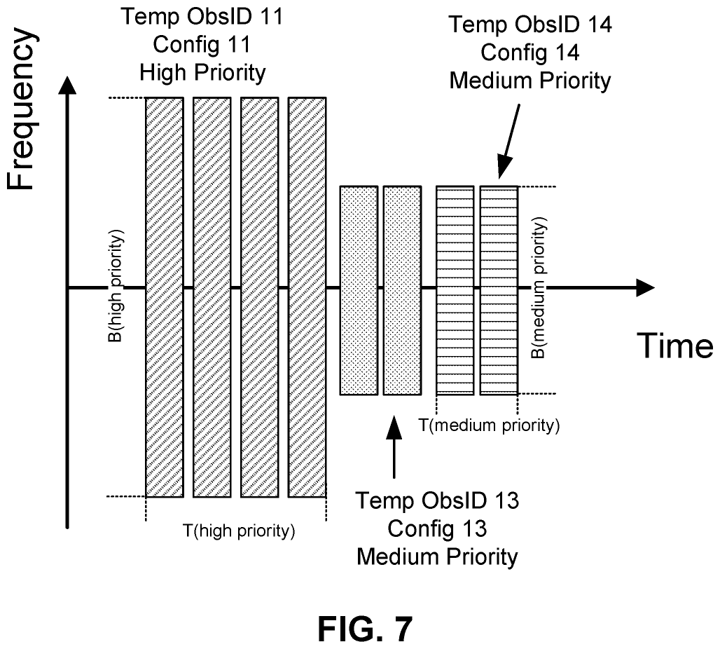

FIG. 7 depicts an example allocation of time and frequency resources to obstacles.

The WTRU may be configured (e.g., by the network) to allocate a proportionate amount of resources with different priority level (e.g., as depicted in FIG. 7). The proportionate amount of resources may refer to the WTRU allocating more resources to the higher priority obstacles compared to the lower priority obstacles.

For example, a high priority may be associated with more resources (e.g., Tₚ=10 ms, Bₚ=72 PRB, θₚ=10 degrees, Comb-2) and/or a low priority may be associated with less resources (e.g., Tₚ=5 ms, Bₚ=24PRB, θₚ=30 degrees, Comb-8).

The WTRU may determine a priority dependent time Tₚ, bandwidth Bₚ, beamwidth θₚ, and/or comb density for a priority level (e.g., each priority level) based on one or more of: a total number obstacles to be located; a total number of obstacles among the obstacles with priority above a (pre) configured threshold; a total unallocated (e.g., available) sensing duration; a total available bandwidth; or a total available energy at the WTRU.

In examples, the WTRU may first allocate priority dependent resources to the obstacles with highest priority and update the available estimation duration, bandwidth, and energy after the allocation. The WTRU may iteratively allocate the resources to lower priority obstacles based on the updated available resources.

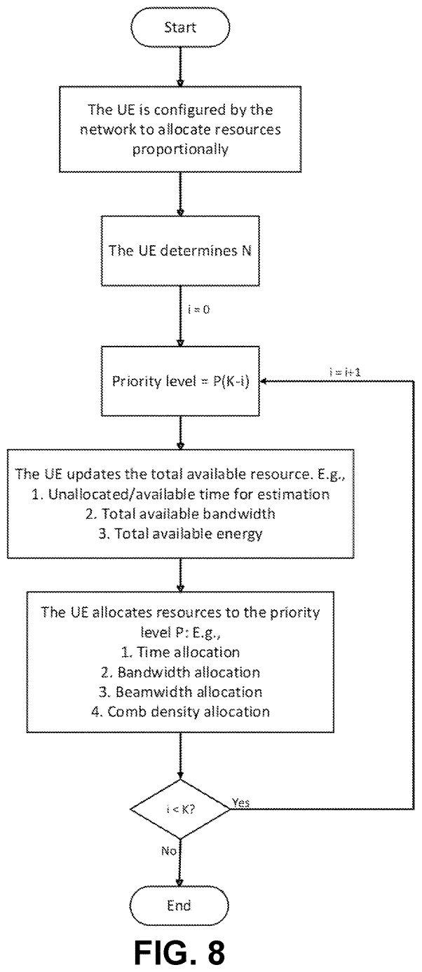

FIG. 8 depicts an example priority dependent resource allocation, where one or more of the actions may be performed. In FIG. 8, K may represent the total levels of priority among obstacles.

The WTRU may be configured (e.g., by the network) to allocate an equal amount of resources for all the priority levels (e.g., in contrast to the proportional allocation depicted in FIG. 7). The WTRU may determine a priority independent time T₀, bandwidth B₀, beamwidth θ₀, and/or comb pattern and may allocate the resources corresponding to the determined time and bandwidth to the obstacles equally. The WTRU may determine these parameters based on one or more of: the total number of obstacles to be located (N), the total unallocated/available sensing duration for the estimation phase, the total available bandwidth for the estimation phase, the total available energy at the WTRU, or the (pre) configured priority dependent time threshold Tₘᵢₙ(p), bandwidth threshold Bₘᵢₙ(p), beamwidth θ(p), and/or comb pattern.

The equal resource allocation may obtain a similar location estimation performance (e.g., in terms of accuracy) for all the obstacles with a priority above a threshold.

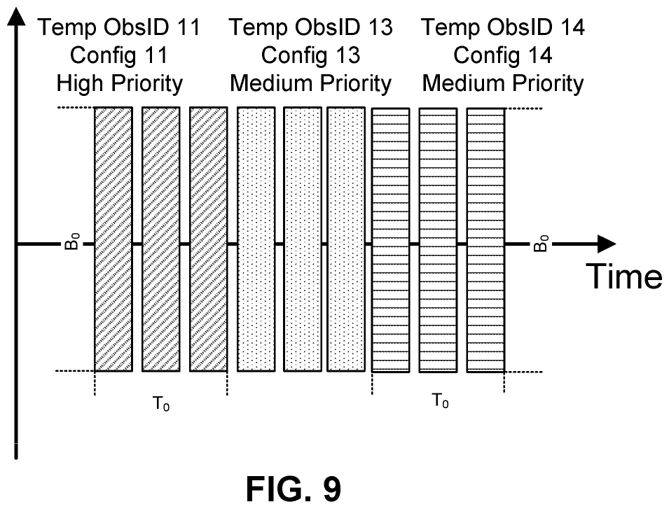

FIG. 9 depicts an example equal time and frequency allocation for N=3 obstacles.

The WTRU may configure the SRSp resources based on configuration parameters associated with priority levels. The WTRU may allocate time and/or frequency resources including the SRSp patterns based in order of priority from highest to lowest.

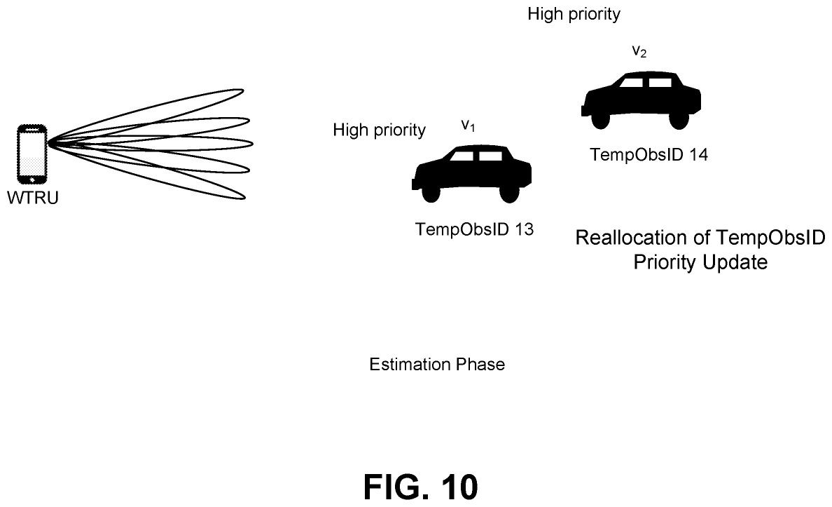

The priority indicated for multiple obstacles may be the same. For example, two high priority obstacles may have the same priority as depicted in FIG. 10. The WTRU may determine the order of estimation based on a determination to estimate one of the obstacles based on the time the obstacle was detected (e.g., based on timestamp) and/or a determination to estimate the obstacles simultaneously multiplexed in frequency.

The WTRU may estimate obstacles based on the time the obstacle was detected. For example, if the WTRU detects two obstacles and that are moving at the same velocity, the WTRU may assign the same priority level to the two obstacles. Based on the time the obstacles are detected, the WTRU may determine to estimate the obstacle with the earliest time stamp. In another example, the WTRU may determine the order of estimation based on the time the obstacle was detected. For example, the WTRU may estimate the location of the obstacle with the earliest time of detection before the WTRU estimates the obstacle with the second earliest time of detection.

The WTRU may estimate obstacles simultaneously multiplexed in frequency. For example, if the WTRU detects two obstacles with the same priority and the bandwidth allocated for each priority can be multiplexed in the frequency domain simultaneously, the WTRU may determine to estimate both the obstacles at the same time instance.

FIG. 10 depicts an example of a narrow spatial scope of an estimation phase.

In an estimation phase, a spatial direction and coverage of SRSp transmission may be narrower compared to a detection phase (e.g., as can be seen by contrasting the example detection phase depicted in FIG. 4 with the example estimation phase depicted in FIG. 10). The WTRU may allocate SRSp beams from either the same resource set as in the detection phase or from a different resource set (e.g., with a different beamwidth).

The WTRU may allocate the spatial beams for each obstacle based on the spatial direction of the triggered detection SRSp resources (e.g., with respect to the AoD and the coverage angle associated with the obstacle), and/or the indicated priority level for the obstacle and the resource set with the associated beamwidth.

The WTRU may receive configurations for more than one set of SRSp beams (e.g., resources). Each set of SRSp beams that may be received by the WTRU may contain different number of beams and each set of beams may be associated with a beamwidth. Beamwidths for different sets of beams may be different. For each obstacle, the WTRU may determine a set of beams to estimate the obstacle based on a priority level associated with the obstacle. The WTRU may be configured with an association rule(s) which associates a set of beams with a priority level. Association of a set of beams with a priority level may enable highly accurate location estimation while resolving issues of reliability.

Feature(s) associated with SRSp transmission, reception, and measurement for the estimation phase are provided herein.

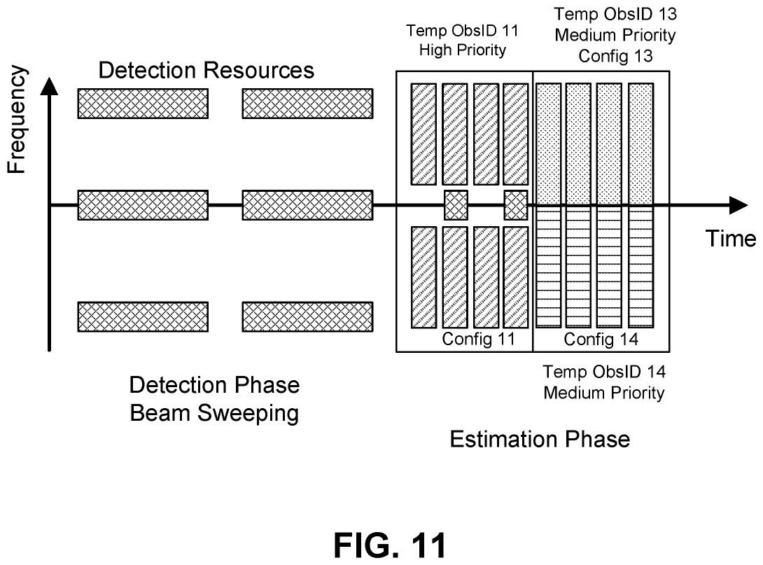

FIG. 11 depicts an example resource allocation for a detection phase and an estimation phase based on determined (e.g., indicated) obstacle priorities. For example, as shown in FIG. 11, each respective detected obstacle may have one or more of: a respective obstacle ID, a respective priority, or a respective set of resources.

The WTRU may transmit configured SRSp resources at an indicated time and frequency resource (e.g., as described herein) and may receive resources reflected back from an obstacle (e.g., in examples herein a measurement may be a measurement of a reflected SRSp). The WTRU may measure the ToF, RSRP, and/or the doppler frequency from the received resources and may use these measurement(s) to determine a location of the obstacle (e.g., estimated location of the obstacle).

If the WTRU knows its location coordinates, the WTRU may estimate the absolute position of a detected obstacle. If the WTRU does not know its location, the WTRU may estimate the relative location of the obstacles with respect to the WTRU.

The WTRU may estimate multiple distinct obstacles with the SRSp resources associated with one definite obstacle ID (e.g., due to the erroneous detection). Because less resources may be used in the detection phase (e.g., time frequency resources, beams with large beamwidths, etc.) than in the estimation phase, the detection may occur with a lower resolution for ToF and/or doppler frequency (e.g., compared to the estimation phase). In the estimation phase, the WTRU may know the AoD and the coverage angle and may be able to allocate large time and frequency resources with the SRSp beams with small beamwidths in a specific direction to resolve and identify multiple obstacles with similar measurements within an area.

If the WTRU locates multiple obstacles (e.g., that may have been previously associated with one definite obstacle ID in the estimation phase), the WTRU may re-assign the located obstacles with a temporary obstacle ID and may allocate the priority of estimation itself and reconfigure the SRSp resources accordingly or may terminate the estimation, report to the network, and/or wait for allocation of the priority.

The WTRU may determine to self-allocate the priority or to wait for the priority from the network based on one or more of the following conditions: an initial indicated priority for the obstacle is above a (pre) configured threshold; an unallocated/available time for estimation is above a (pre) configured threshold; a time allocated to obstacles (e.g., with lower priority compared to the initial indicated priority) is above a (pre) configured threshold; an available bandwidth for estimation is above a (pre) configured threshold; or energy available at the WTRU for estimation is above a (pre) configured threshold.

If the initial indicated priority for the obstacle is above a (pre) configured threshold the WTRU may determine to reallocate the priority and the resources (e.g., for high priority obstacles). If the initial indicated priority for the obstacle is at or below a (pre) configured threshold the WTRU may determine to wait for the network for priority allocation (e.g., for medium or low priority obstacles).

The WTRU may determine to reconfigure the SRSp resources allocated to the obstacles, for example, if the WTRU detects and allocates a priority to an obstacle (e.g., a previously undetected obstacle) during the estimation phase. The WTRU may determine to assign unallocated time and frequency resources if available and/or reassign previously allocated time and frequency resources from obstacle(s) with a lower priority (e.g., if the time and/or frequency resources are unavailable).

The WTRU may re-estimate the AoD and the coverage angle related to located obstacles. Because an obstacles location may be estimated with a higher accuracy during the estimation phase and multiple obstacles may be additionally resolved, the WTRU may update or reallocate the AoDs and the coverage angles to the obstacles.

In examples, one or more of the following may be performed. The WTRU may receive configuration information from the network for obstacle sensing, which may include one or more of: SRSp resource sets, time and frequency resources, periodicity, RSRP threshold(s), or ToF threshold(s). The WTRU may receive an indication from the network to initiate detection (e.g., a detection phase) with a time threshold. The WTRU may detect an obstacle (e.g., based on a positioning transmission, such as an SRSp transmission as described herein), assign a temporary obstacle ID to the obstacle, and/or report (e.g., to the network) the obstacle along with the temporary obstacle ID and/or measurement(s) (e.g., measurement(s) associated with the positioning transmission). The WTRU may receive (e.g., from the network) a definite obstacle ID, a priority associated with the definite obstacle ID, and/or an association mode (e.g., resource allocation based on priority, such as proportional allocation or equal allocation). The WTRU may determine to perform and/or perform estimation according to the indicated priority level per detected obstacle and may determine configurations (e.g., SRSp resources in time, frequency, periodicity, etc.) for the estimation phase (e.g., based on the definite obstacle ID and/or the associated priority). The WTRU may locate multiple obstacles from measurements associated with the configuration(s) associated with the same obstacle ID. The WTRU may (re) assign temporary obstacle IDs to the obstacles having the same obstacle ID and may associate the set of measurements to them. The WTRU may report the temporary obstacle IDs, the associated set of measurements, and the associated definite obstacle ID to the network. The WTRU may determine to terminate the sensing procedure once the timer reaches threshold.

Feature(s) associated with detection resources in the estimation phase are provided herein.

The WTRU may allocate detection resources in the estimation phase. FIG. 11 depicts an example where the detection resources may be present (e.g., partly present) during configuration of obstacle with ID TempObsID 11. Since the resources for the estimation phase may be confined to a certain spatial direction (e.g., the WTRU may not estimate other obstacles around it, for example in a different direction), the WTRU may determine to transmit the detection resources. The detection resources may be transmitted with the same previous configuration, reconfigured with different time/frequency allocation, and/or terminated during the estimation phase.

The WTRU may reconfigure detection resources in the estimation phase. The reconfiguration may be dependent on the priority dependent SRSp resource allocation in the estimation phase. The WTRU may perform one or more of the following: terminate the detection resources during the estimation of high priority obstacles; re-initiate the detection resources during the estimation of low priority obstacles; reduce the bandwidth and number of symbols symbol during the estimation phase; or increase the gap (e.g. reduce the frequency of detection) between multiple detection occasions.

Feature(s) associated with reporting in the estimation phase are provided herein.

The WTRU may report the located obstacles to the network. The WTRU may report one or more of: definite obstacle ID(s), temporary obstacle ID(s), estimated location(s) of the obstacle(s), indication(s) of whether a location(s) is absolute or relative location, associated AoD, associated coverage angle, associated measurements (e.g., RSRP, ToF, ToA, doppler shift), SRSp resource(s) or SRSp resource ID(s) and/or SRSp resource set(s) or SRSp resource set ID(s) and or any other information related to SRSp resource associated with the measurements for obstacle location estimation, timestamp associated with the measurements or WTRU indicated priority (e.g., in case of reprioritization).

Feature(s) associated with changes in the WTRU state or obstacle state are provided in.

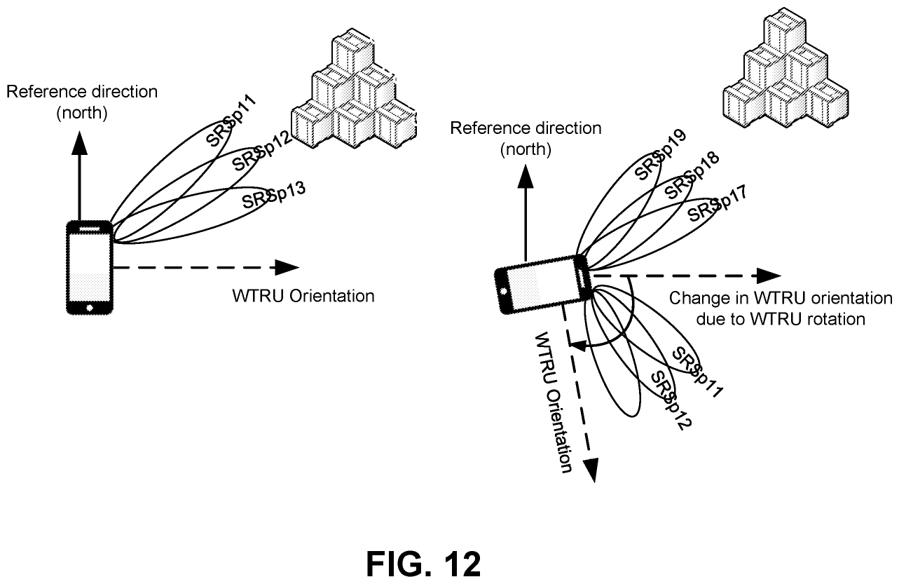

FIG. 12 depicts an example SRSp resource misalignment due to a change in WTRU orientation and an example reallocation of the resources.

The WTRU may be configured (e.g., by the network) to report a change in the WRTU's state (e.g., the position and/or orientation of the WTRU) to the network.

A change in the position or orientation of the WTRU may be indicated by a difference in the position and/or orientation between two measurement occasions above a (pre) configured threshold.

A change in the position of the WTRU may affect the accuracy of the obstacle's location. With a change in the position of the WTRU, the obstacle(s) may be misaligned with the estimated AoD(s) (e.g., may be partially or completely out of the area of the coverage angle(s) and/or the obstacle(s) may still be aligned with the AoD(s) but may require an increase or decrease in the coverage angle(s).

If the WTRU determines a complete misalignment has occurred, the WTRU may estimate no obstacle(s) despite detecting it. If the WTRU determines a partial misalignment has occurred, some SRSp resources in the coverage area may not estimate the location of the obstacle(s) and may provide erroneous measurements. If erroneous measurements are averaged with the estimates from non-misaligned SRSp beams in the coverage area, it may result in an inaccurate location estimation.

A change in orientation of WTRU may result in an erroneous estimation of an obstacle's location as illustrated in FIG. 12. Because the reference direction of the AoD and the corresponding coverage angle may be based on the orientation of the WTRU, a change in orientation of the WTRU may result in the obstacle(s) being misaligned with the estimated AoD(s) (e.g., the obstacle(s) may be partially or completely out of the area of the coverage angle(s).

The WTRU may be configured to report a change (e.g., any change) of state of the obstacle(s) (e.g., changes to the obstacle's position or velocity). The WTRU may detect any change in the position and/or velocity of the obstacle(s) based on the difference in estimated location and/or velocity of the obstacle(s) measured in two separate measurement occasions associated with the same obstacle ID (e.g., temporary obstacle ID or definite obstacle ID).

A change in position of the obstacle(s) may affect the accuracy of the WTRU's location estimation for the obstacle(s). A change in the position of an obstacle(s) may result in the obstacle(s) being misaligned with the estimated AoD(s) (e.g., the obstacle(s) may be partially or completely out of the area of the coverage angle(s)), the obstacle(s) still being aligned with the AoD(s) but requiring an increase or decrease in the coverage angle(s), and/or the obstacle(s) being aligned with the AoD such that the obstacle(s) may be in the coverage area of another obstacle.

A change in position of the obstacle(s) may introduce additional ambiguity in the location estimation and hence may reduce the accuracy with which the location of the obstacle may be estimated.

A change in the velocity of the obstacle may introduce ambiguities in the accuracy of location estimations. For example, a velocity change may result in the obstacle(s) being misaligned with the estimated AoD(s) (e.g., the obstacle(s) may be partially or completely out of the area of the coverage angle(s)).

Feature(s) associated with measurement validity are provided herein.

The WTRU may indicate or report any invalidity of the measurement (e.g., to the network) if the WTRU detects a change in its state.

An indication or report may be triggered by the WTRU detecting any change in its position and/or orientation, for example, after the WTRU has reported its measurements. A change in state may invalidate any measurement reported before. In such cases, the WTRU may be re-configured to reinitiate the detection phase, re-configured to reinitiate the estimation phase, and/or indicated to terminate the sensing process.

The WTRU may detect any changes to its position and/or orientation after it has made the measurements but before the measurement report. In that case, the WTRU may report the measurement with an indication, such as a flag (e.g., ON, 1 etc.). This indication (e.g., flag) in the measurement report may be an indication by the WTRU to the network to treat the measurements separately (e.g., readjust the measurements with the changed position/orientation before processing). In examples, the flag may be included (e.g., may always be included) in the measurement report. In examples, the flag may be included (e.g., may only be included) if/when the measurement environment changes (e.g., the WTRU rotates more than a configured threshold).

The WTRU may indicate a timestamp to indicate a time a measurement was made. For example, a timestamp may be expressed in terms of symbol index, slot index, system frame index, frame or subframe index, absolute time, and/or relative time. The WTRU may indicate a validity duration of the measurement. The validity duration may be expressed in terms of the number of symbols, slots, frames, time (e.g., hours).

The WTRU may report SRSp resource or SRSp resource ID(s) and/or SRSp resource set(s) or SRSp resource set ID(s) or any other information related to SRSp resource configuration before and/or after the determination of change of state of the UE or the obstacle to the network.

Feature(s) associated with WTRU behavior after indication are provided herein.

The WTRU may receive (e.g., after reporting the change in state of the WTRU or the obstacle) an indication (e.g., from the network) with an updated AoD, coverage angle, and/or priority, where each may be associated with the definite obstacle ID. The WTRU may update an estimated AoD and/or coverage angle and/or reprioritize each obstacle based on a detected change in the WTRU and/or the obstacle(s) state.

The WTRU may update AoDs and the coverage angles for each obstacle in the event of state change detection by one or more of: realigning AoD in case of misalignment (e.g., due to change in position of the WTRU and/or the obstacle); increasing coverage angle (e.g., due to estimated reduction in distance between the WTRU and the obstacle); decreasing coverage angle (e.g., due to estimated increase in distance between the WTRU and the obstacle); realigning AoD in case of misalignment (e.g., due to change in WTRU orientation); increasing in coverage angle (e.g., due to increase of the obstacle velocity); decreasing coverage angle (e.g., due to decrease of the obstacle velocity); or increasing coverage angle due to increase in location estimation uncertainty (e.g., due to change in WTRU location, orientation, obstacle position, and/or velocity).

The WTRU may reprioritize the estimation of obstacles by one or more of: increasing the indicated priority of estimation (e.g., due to an increase in obstacle velocity); decreasing the indicated priority of estimation (e.g., due to a decrease in obstacle velocity); increasing the indicated priority (e.g., due to an estimated decrease in the distance between the WTRU and the obstacle); or decreasing the indicated priority (e.g., due to an estimated increase in the distance between the WTRU and the obstacle).

In examples, one or more of the following may be performed. The WTRU may receive the configurations (e.g., from the network) for obstacle sensing (e.g., SRSp resource sets, time and frequency resources, periodicity and RSRP/ToF threshold). The WTRU may receive an indication from the network to initiate the detection phase with a time threshold. The WTRU may detect an obstacle, estimate its location, and assign an obstacle ID to it. The WTRU may associate the obstacle ID with one or more of: an AoD (e.g., AoD of SRSp beams with strongest RSRP, mean AoD of SRSp beams associated with the obstacle) corresponding to the obstacle location, a coverage angle (e.g., total aggregated width of the SRSp associated with the obstacle) corresponding to obstacle location, or an indicated obstacle priority. The WTRU may report the obstacle ID and/or the associated metrics to the network.

The WTRU may receive an updated AoD, coverage angle, and/or priority from the network (e.g., based on changes in WTRU state (e.g., position, orientation), obstacle state (e.g., location, velocity), etc.,) associated with the obstacle ID.

The WTRU may configure SRSp resources to reflect the indicated updates (e.g., allocation of time, frequency resources according to the indicated priority, allocation of multiple SRSp resources in the updated AoD direction spanning the coverage angle).

The WTRU may make measurements per obstacle and estimate its location. In examples, as described herein, the WTRU may associate the obstacle IDs with the estimated location and the indicated priority.

The WTRU may report the obstacle ID, the associated metrics, its estimated location, and/or the priority to the network.

The WTRU may determine whether to terminate the sensing procedure (e.g., based on a timer reaching a threshold).

A device, such as a WTRU, may (e.g., be configured to) perform one or more of the following. The device may detect an obstacle based on a positioning transmission associated with obstacle sensing. For example, the device may detect the obstacle by determining a difference between a measured reference signal received power (RSRP) between measurement occasions exceeds a threshold. The device may associate a temporary obstacle ID with the detected obstacle. The device may send, e.g., to a network device, an indication of measurement information associated with the obstacle and the temporary obstacle ID.

The device may receive, e.g., from the network device, an indication of a definite obstacle ID associated with the temporary obstacle ID. The device may determine a set of resources associated with the obstacle based on a priority associated with the definite obstacle ID. In examples, the priority associated with the definite obstacle ID may be provided by the network (e.g., via the indication including the definite obstacle ID) or may be determined by the device. For example, the device may determine a priority associated with the definite obstacle ID based on a distance between the WTRU and the obstacle, an estimated velocity of the obstacle, a direction of movement of the obstacle, and/or a measured reference signal received power (RSRP) associated with the obstacle.

A priority may be associated with a set of resources (e.g., each respective priority may be associated with a respective set of resources). The set of resources may be allocated proportionally, based on priority, or equally. In examples, a higher priority obstacle may be allocated a higher amount of resources. Similar resources may be allocated for obstacles with a priority above a threshold. The set of resources may be based on a number of obstacles to be located or a number of obstacles with a respective priority above a priority threshold.

The device may perform a measurement associated with a transmission of a SRSp in the set of resources to determine an estimated location of the obstacle. The device may send estimated location information associated with the obstacle to the network. The estimated location information associated with the obstacle may indicate the definite obstacle ID, the estimated location associated with the obstacle, and/or the priority associated with the obstacle.

Although features and elements described above are described in particular combinations, each feature or element may be used alone without the other features and elements of the preferred embodiments, or in various combinations with or without other features and elements.

Although the implementations described herein may consider 3GPP specific protocols, it is understood that the implementations described herein are not restricted to this scenario and may be applicable to other wireless systems. For example, although the solutions described herein consider LTE, LTE-A, New Radio (NR) or 5G specific protocols, it is understood that the solutions described herein are not restricted to this scenario and are applicable to other wireless systems as well.

The processes described above may be implemented in a computer program, software, and/or firmware incorporated in a computer-readable medium for execution by a computer and/or processor. Examples of computer-readable media include, but are not limited to, electronic signals (transmitted over wired and/or wireless connections) and/or computer-readable storage media. Examples of computer-readable storage media include, but are not limited to, a read only memory (ROM), a random access memory (RAM), a register, cache memory, semiconductor memory devices, magnetic media such as, but not limited to, internal hard disks and removable disks, magneto-optical media, and/or optical media such as compact disc (CD)-ROM disks, and/or digital versatile disks (DVDs). A processor in association with software may be used to implement a radio frequency transceiver for use in a WTRU, terminal, base station, RNC, and/or any host computer.

1. A wireless transmit/receive unit (WTRU) comprising:
a processor configured to:
detect an obstacle based on a positioning transmission associated with obstacle sensing;
send, to a network device, an indication of measurement information associated with the obstacle and a temporary obstacle ID associated with the obstacle;
receive, from the network device, an indication of a definite obstacle ID associated with the obstacle;
determine a set of resources associated with the obstacle based on a priority associated with the definite obstacle ID;
perform a measurement associated with a transmission of a SRSp in the set of resources;
determine an estimated location associated with the obstacle, wherein the determination of the estimated location associated with the obstacle is based on the measurement; and
send estimated location information associated with the obstacle.

2. The WTRU of claim 1, wherein if the priority is a first priority the set of resources is determined to be a first set of resources, and wherein if the priority is a second priority the set of resources is determined to be a second set of resources.

3. The WTRU of claim 1, wherein the estimated location information associated with the obstacle indicates one or more of: the definite obstacle ID, the estimated location associated with the obstacle, or the priority.

4. The WTRU of claim 1, wherein the processor is further configured to receive, from the network device, the priority associated with the definite obstacle ID.

5. The WTRU of claim 1, wherein the processor is further configured to determine the priority associated with the definite obstacle ID based on at least one of a distance between the WTRU and the obstacle, an estimated velocity of the obstacle, or a direction of movement of the obstacle.

6. The WTRU of claim 1, wherein the processor is further configured to determine the priority associated with the definite obstacle ID based on a measured reference signal received power (RSRP) associated with the obstacle.

7. The WTRU of claim 1, wherein a resource in the set of resources is based on at least one of a number of obstacles to be located or a number of obstacles with a respective priority above a priority threshold.

8. The WTRU of claim 1, wherein the processor being configured to detect the obstacle comprises the processor determining a difference between a measured reference signal received power (RSRP) associated with a previous measurement occasion and a measured RSRP associated with a current measurement occasion is above a threshold.

9. The WTRU of claim 1, wherein the measurement information is associated with a reflection of a SRSp transmission.

10. The WTRU of claim 1, wherein the WTRU is a first WTRU, and wherein the processor is further configured to perform one or more of:
send a message to a second WTRU, wherein the message to the second WTRU indicates the definite obstacle ID; or
receive a message from the second WTRU, wherein the message from the second WTRU indicates the definite obstacle ID.

11. A method implemented in a wireless transmit/receive unit (WTRU) comprising:
detecting an obstacle based on a positioning transmission associated with obstacle sensing;
sending, to a network device, an indication of measurement information associated with the obstacle and a temporary obstacle ID associated with the obstacle;
receiving, from the network device, an indication of a definite obstacle ID associated with the obstacle;
determining a set of resources associated with the obstacle based on a priority associated with the definite obstacle ID;
performing a measurement associated with a transmission of a SRSp in the set of resources;
determining, based on the measurement, an estimated location associated with the obstacle; and
sending estimated location information associated with the obstacle.

12. The method of claim 11, wherein if the priority is a first priority the set of resources is determined to be a first set of resources, and wherein if the priority is a second priority the set of resources is determined to be a second set of resources.

13. The method of claim 11, further comprising receiving, from the network device, the priority associated with the definite obstacle ID.

14. The method of claim 11, further comprising determining the priority associated with the definite obstacle ID based on at least one of a distance between the WTRU and the obstacle, an estimated velocity of the obstacle, or a direction of movement of the obstacle.

15. The method of claim 11, further comprising determining the priority associated with the definite obstacle ID based on a measured reference signal received power (RSRP) associated with the obstacle.

16. The method of claim 11, wherein a resource in the set of resources is based on at least one of a number of obstacles to be located or a number of obstacles with a respective priority above a priority threshold.

17. The method of claim 11, wherein the WTRU is a first WTRU, and wherein the method further comprises one or more of:
sending a message to a second WTRU, wherein the message to the second WTRU indicates the definite obstacle ID; or
receiving a message from the second WTRU, wherein the message from the second WTRU indicates the definite obstacle ID.
